(19) United States
(12) Patent Application Publication
(10) Pub. No.: US 2016/0124230 A1
(43) Pub. Date: May 5, 2016

(54) IMAGE DISPLAY DEVICE AND DRAWING METHOD

(71) Applicant: Seiko Epson Corporation, Tokyo (JP)

(72) Inventors: Makiko HINO, Matsumoto (JP); Shuichi WAKABAYASHI, Okaya (JP)

(21) Appl. No.: 14/925,103

(22) Filed: Oct. 28, 2015

(30) Foreign Application Priority Data
Oct. 31, 2014 (JP) 2014-222467

(51) Int. Cl. G02B 27/01; G02B 26/10; G02B 5/32; G02B 27/00; G06T 19/00; G06F 3/01

(52) U.S. Cl. CPC G02B 27/0172; G06T 19/006; G06F 3/013; G02B 5/32; G02B 27/0093; G02B 27/0176; G02B 26/105; G02B 2027/0178; G02B 2027/0174; G02B 2027/0159; G02B 2027/0138; G02B 2027/014

(57) ABSTRACT

An image display device includes: a light source section adapted to emit a laser beam; a drawing section adapted to make a mirror reflect the laser beam, and rotate the mirror to draw an image; a display section adapted to reflect the laser beam to form a virtual image; a moving section adapted to move the drawing section and the display section in conjunction with each other; a visual line detection section adapted to detect a visual line of an observer observing the virtual image; and a control section adapted to control the moving section in accordance with a movement of the visual line.

### BACKGROUND

1. Technical Field

The present invention relates to an image display device and a drawing method.

2. Related Art

There has been studied an image display device for displaying an image by scanning the retina of the observer with a light beam. Such an image display device is used for a head mounted display and a head-up display. Since the configuration for generating an image can be made simple with such an image display device, reduction in size and weight can be achieved.

In International Patent Publication No. 2009/0066475, there is disclosed a display device for displaying an image on the retina of the observer. According to International Patent Publication No. 2009/0066475, the image display device is provided with a light source for emitting red, blue, and green laser beams. The laser beams emitted by the light source are output toward a mirror disposed inside a drawing section. The drawing section oscillates the mirror to control the proceeding directions of the laser beams to thereby draw an image. With the laser beams output from the drawing section, the hologram mirror is irradiated. The hologram mirror is provided with an interference pattern, and the hologram mirror changes the proceeding directions of the laser beams toward the pupil of the observer.

When the observer moves the visual line, the pupils of the observer move. When the laser beam reflected by the hologram mirror is shifted from the pupil, it becomes unachievable for the observer to observe a virtual image. In the image display device of International Patent Publication No. 2009/0066475, the light detection section detects the direction of the visual line. The drawing section changes the position of the virtual image displayed on the hologram mirror. Thus, the virtual image is moved in the direction of the visual line.

However, in order for the observer to observe the virtual image, it is necessary for the laser beams to pass through the pupils of the observer. When fixing the drawing section and the hologram mirror, and changing the position of the virtual image to be projected, the laser beams fail to enter the pupils of the observer in some cases. In this case, the observer becomes unable to see the virtual image. Therefore, there has been demanded an image display device for projecting the virtual image so that the laser beams pass through the pupils of the observer.

### SUMMARY

An advantage of some aspects of the invention can be implemented as the following forms or application examples.

### Application Example 1

An image display device according to this application example includes a light source section adapted to emit a laser beam, a drawing section adapted to make a mirror reflect the laser beam, and rotate the mirror to draw an image, a display section adapted to reflect the laser beam to form a virtual image, a moving section adapted to move the drawing section and the display section in conjunction with each other, a visual line detection section adapted to detect a visual line of an observer observing the virtual image, and a control section adapted to control the moving section in accordance with a movement of the visual line.

According to this application example, the light source section emits the laser beam. The laser beam emitted is reflected by a mirror of the drawing section, and the display section is irradiated with the laser beam thus reflected. The drawing section rotates the mirror to perform drawing on the display section, and the display section forms the virtual image. In the case in which the observer observing the virtual image moves the visual line, the visual line detection section detects the visual line of the observer. The control section controls the moving section, and the moving section moves the drawing section and the display section in conjunction with each other. Thus, the image display device moves the virtual image in accordance with the motion of the visual line of the observer. It is possible for the image display device to project the virtual image so that the laser beams pass through the pupils of the observer. Therefore, it is possible for the image display device to display a clear image in accordance with the visual line of the observer.

### Application Example 2

In the image display device according to the application example described above, the moving section includes a connection section adapted to connect the drawing section and the display section to each other.

According to this application example, the moving section has the connection section adapted to connect the drawing section and the display section to each other. Due to the connection section, the drawing section and the display section move in conjunction with each other in a predetermined positional relationship. By moving either one of the drawing section and the display section, it is possible for the moving section to move the drawing section and the display section in conjunction with each other. As a result, it is possible to adopt a simpler structure compared to the case in which the moving section moves the drawing section and the display section separately from each other.

### Application Example 3

In the image display device according to the application example described above, the image display device further includes a protecting section provided with a window section having a light transmissive property, and the display section is disposed in the protecting section.

According to this application example, the display section is disposed inside the protecting section. The protecting section is provided with the window section having a light transmissive property. Therefore, the display section is irradiated with the laser beam through the window section, and the display section can form the virtual image. In the case in which the display section is moved by the moving section, the display section is disposed inside the protecting section, and is protected by the protecting section. Therefore, it is possible to prevent the display section from having contact with the observer to be scraped. As a result, the display section can be prevented from being contaminated.

### Application Example 4

In the image display device according to the application example described above, the display section has a plate having a heat resistance property on which a hologram sheet is disposed.

According to this application example, the display section has the plate on which the hologram sheet is disposed. The hologram sheet diffracts the laser beam to thereby change the proceeding direction of the laser beam. Therefore, the concavity and convexity of the plate can be made shallow. Therefore, since the plate can be made thinner, it is possible to lighten the plate to thereby move the display section with high response. Since the plate has a heat resistance property, it is possible to inhibit the deformation due to heating by the laser beam.

### Application Example 5

In the image display device according to the application example described above, the display section has a frame section on which a hologram sheet is disposed.

According to this application example, the display section has the frame section. The frame section has certain rigidity, and it is possible to thin a part irradiated with the laser beam to thereby reduce the weight of the display section. Therefore, the display section can be moved with high response.

### Application Example 6

In the image display device according to the application example described above, the window sections are disposed across the display section from each other.

According to this application example, the window sections are disposed across the display section from each other. Therefore, a part of the light passing through the window section can proceed through the display section and then further proceed through the window section. Therefore, it is possible for the observer to receive the light passing through the window section and the display section in addition to the laser beam.

### Application Example 7

A drawing method according to this application example includes shooting a pupil of an observer to detect a visual line of the observer, moving a display section and a drawing section to a place where a laser beam passes through the pupil of the observer, and emitting the laser beam from the drawing section to the display section to draw a virtual image.

According to this application example, the pupils of the observer are shot to detect the visual line of the observer. The display section and the drawing section are moved to the place where the laser beams pass through the pupils of the observer. Then, the laser beam is emitted from the drawing section to the display section to draw the virtual image. Therefore, since the laser beams for drawing pass through the pupils of the observer, the virtual images drawn by the laser beams are surely projected on the respective retinas of the observer. As a result, it is possible for the image display device to display a clear image in accordance with the visual line of the observer.

### BRIEF DESCRIPTION OF THE DRAWINGS

The invention will be described with reference to the accompanying drawings, wherein like numbers reference like elements.

FIG. 1 is a schematic perspective view showing a configuration of a head mounted display according to a first embodiment of the invention.

FIG. 2A is a schematic side cross-sectional view of a principal part showing a structure of a drawing section and a half mirror, FIG. 2B is a schematic top view of a principal part showing the structure of the drawing section and the half mirror, and FIG. 2C is a schematic top view of a principal part showing a structure of a mirror protecting section and the half mirror.

FIG. 3 is a block diagram showing a configuration of a projector section.

FIG. 4 is a plan view showing a light scanning section provided to the drawing section.

FIG. 5 is a side cross-sectional view of the light scanning section.

FIG. 6 is a block diagram of a voltage applying section.

FIGS. 7A and 7B are diagrams for explaining a voltage generated by a voltage generation section.

FIG. 8 is an electrical control block diagram of the head mounted display.

FIG. 9 is a flowchart showing a drawing method.

FIGS. 10A through 10C are schematic diagrams for explaining the drawing method.

FIGS. 11A through 11C are schematic diagrams for explaining the drawing method.

FIGS. 12A and 12B relate to a second embodiment of the invention, wherein FIG. 12A is a schematic horizontal cross-sectional view of a principal part showing a structure of a head mounted display, and FIG. 12B is a schematic top cross-sectional view of a principal part showing the structure of the head mounted display.

FIGS. 13A through 13C are schematic diagrams for explaining an action of a half mirror.

FIG. 14 is a schematic perspective view of a principal part showing a structure of a head mounted display according to a third embodiment of the invention.

FIG. 15 is a schematic perspective view of a principal part showing a structure of a head mounted display according to a fourth embodiment of the invention.

FIG. 16 is a schematic perspective view of a principal part showing a structure of a head mounted display according to a fifth embodiment of the invention.

FIG. 17 is a schematic horizontal cross-sectional view of a principal part showing a structure of a head mounted display according to a sixth embodiment of the invention.

FIG. 18 is a schematic top cross-sectional view of a principal part showing a structure of a head mounted display according to a seventh embodiment of the invention.

FIGS. 19A and 19B relate to an eighth embodiment of the invention, wherein FIG. 19A is a schematic horizontal cross-sectional view of a principal part showing a structure of a head mounted display, and FIG. 19B is a schematic top cross-sectional view of a principal part showing a structure of the head mounted display.

### DESCRIPTION OF EXEMPLARY EMBODIMENTS

In the description of the embodiments of the invention, some head mounted displays each having a characteristic structure as the embodiments will be explained with reference to the accompanying drawings. The members in each of the drawings are illustrated in the respective scales different from each other in order to provide the members with recognizable sizes in the drawing.

### First Embodiment

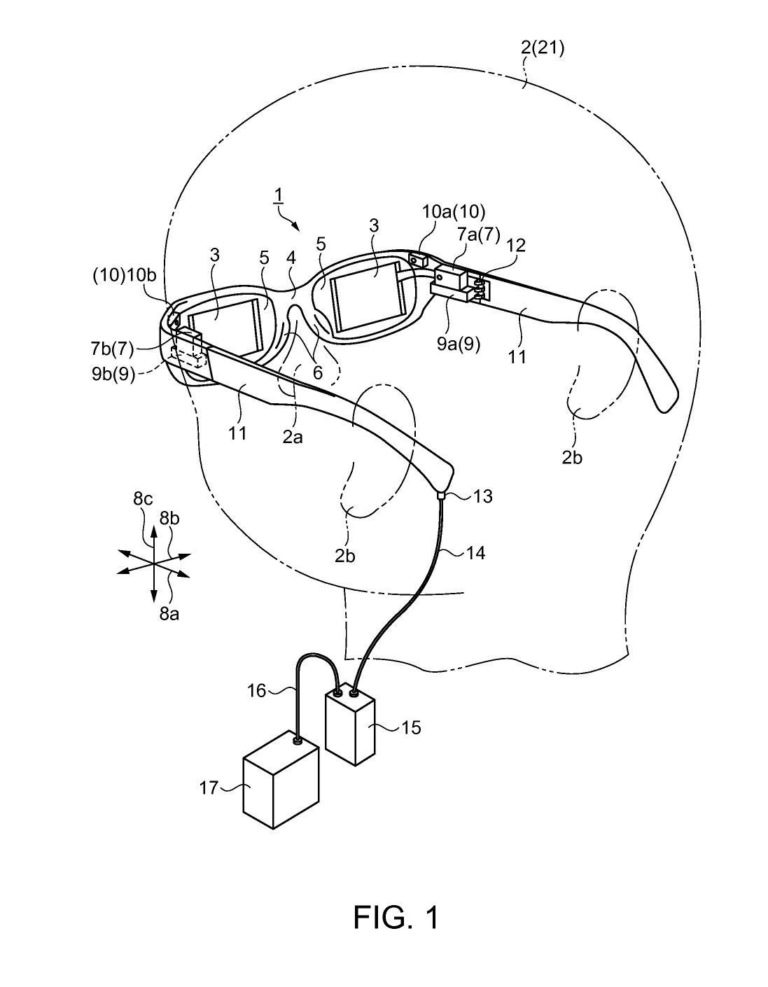

The head mounted display according to the first embodiment will be explained with reference to FIGS. 1 through 11C. FIG. 1 is a schematic perspective view showing a configuration of the head mounted display. As shown in FIG. 1, a head mounted display 1 as an image display device has a shape similar to a pair of glasses, and is mounted on a human head 2 when used.

The head mounted display 1 is provided with half mirrors 3 as a pair of display sections and a half mirror frame 4 for supporting the half mirrors 3. The half mirrors 3 each have a roughly rectangular plate-like shape having a concave surface, and are disposed at places opposed to the eyes of the human head 2. The half mirrors 3 are disposed in respective mirror protecting sections 5 as a protecting section, and the half mirror frame 4 surrounds the peripheries of the mirror protecting sections 5 to support the mirror protecting sections 5. A nose pad 6 projecting toward the human head 2 is disposed on apart of the half mirror frame 4 located between the half mirrors 3, and the nose pad 6 is disposed so as to have contact with a nose 2a of the human head 2. The nose pad 6 has a function of making the head mounted display 1 have contact with and be fixed to the human head 2.

The half mirror frame 4 is provided with drawing devices 7 each having a roughly rectangular solid shape disposed on the both ends of the half mirror frame 4. The drawing devices 7 are each disposed on an opposed side of the half mirror 3 to the nose pad 6. One drawing device 7 is disposed for one half mirror 3. In the half mirror frame 4, there are disposed two half mirrors 3 and two drawing devices 7. The drawing device 7 located on the right side in the drawing is referred to as a right-side drawing device 7a, and the drawing device 7 located on the left side in the drawing is referred to as a left-side drawing device 7b.

The half mirror frame 4 is provided with stages 9 as moving sections for respectively moving the drawing devices 7 in a front-back direction 8a of the human head 2. The stage 9 located on the right side in the drawing is referred to as a right-side stage 9a, and the stage 9 located on the left side in the drawing is referred to as a left-side stage 9b. The right-side stage 9a moves the right-side drawing device 7a, and the left-side stage 9b moves the left-side drawing device 7b. A direction perpendicular to the front-back direction 8a is referred to as a horizontal direction 8b. The horizontal direction 8b is a direction in which the right eye and the left eye are arranged in the human head 2. A direction perpendicular to the front-back direction 8a and the horizontal direction 8b is referred to as a vertical direction 8c. The vertical direction 8c is a direction passing through the foot and the head of an observer 21 in the state in which the observer 21 stands upright.

The stages 9 are each provided with a stationary table and a movable table, and the movable table moves with respect to the stationary table. The stationary tables are disposed on the half mirror frame 4, and the movable tables are connected to the respective drawing devices 7. The stages 9 are each provided with a direct drive mechanism, and as the direct drive mechanism, there can be used a variety of mechanisms such as a linear motor or a device having a ball screw and a rotary motor combined with each other. In the present embodiment, there is used a device having a ball screw and a rotary motor combined with each other, for example, and as the rotary motor, there is used a stepping motor. The moving amount of the stage 9 is not particularly limited, but is set to about 1 cm, for example, in the present embodiment.

On the half mirror frame 4, there are disposed imaging devices 10 each located between the mirror protecting section 5 and the drawing device 7. The imaging devices 10 shoot the eyes of the human head 2, respectively. On the half mirror frame 4, there are disposed two imaging devices 10. The imaging device 10 disposed on the right side of the half mirror frame 4 is referred to as a right-side imaging device 10a, and the imaging device 10 disposed on the left side of the half mirror frame 4 is referred to as a left-side imaging device 10b. The right-side imaging device 10a shoots the right eye, and the left-side imaging device 10b shoots the left eye.

As the imaging device 10, there can be used a solid-state imaging element such as a CCD (charge coupled device) image sensor or a CMOS (complementary metal oxide semiconductor) image sensor, or an electron tube imaging device. In the present embodiment, for example, a CMOS image sensor is used as the imaging device 10.

Temple sections 11 are disposed at both ends of the half mirror frame 4 so as to extend toward ears 2b of the human head 2, respectively. The temple sections 11 are held behind the ears 2b when used similarly to a pair of glasses. A hinge 12 is disposed between each of the temple sections 11 and the half mirror frame 4, and the temple section 11 is arranged to be rotatable around the hinge 12. It is arranged that the head mounted display 1 can be provided with a shape easy to store by folding the temple sections 11 with respect to the half mirror frame 4. The shapes of the half mirrors 3, the half mirror frame 4, the mirror protecting sections 5, and the temple sections 11 are not limited to the shapes shown in the drawings, but a variety of shapes can be adopted.

In the temple section 11 located on the left side, a connector 13 is disposed at a place located in the back of the human head 2, and a cable 14 is connected to the connector 13. A control section 15 is connected to the cable 14. The control section 15 is a device for controlling the drawing devices 7, the stages 9, and the imaging devices 10. To the control section 15, there is connected a video signal output device 17 via a cable 16.

The video signal output device 17 is a device for outputting a stereo video signal to the control section 15. The video signal output device 17 represents a handheld terminal such as a blu-ray disk player, a personal computer, or a smartphone. The control section 15 receives the video signal input to separate the video signal into luminance signals of red, blue, and green colors. Further, the control section 15 extracts scan signals formed of a vertical scan signal and a horizontal scan signal from the video signal. The control section 15 outputs the scan signals formed of the vertical scan signal and the horizontal scan signal to the drawing devices 7 via the cable 14. Further, the drawing devices 7 are respectively provided with light source sections, and the control section 15 outputs the luminance signals of red, blue, and green colors to the light source sections.

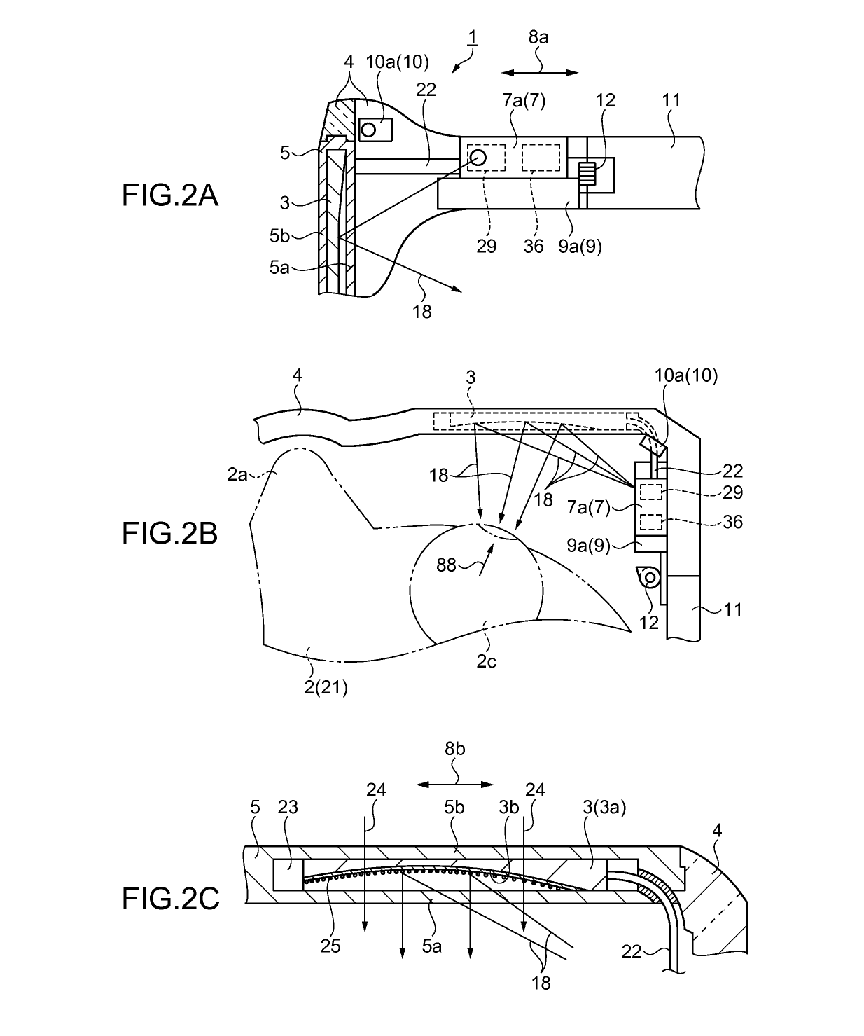

FIG. 2A is a schematic side cross-sectional view of a principal part showing a structure of a drawing section and the half mirror. FIG. 2B is a schematic top view of a principal part showing the structure of the drawing section and the half mirror. FIG. 2C is a schematic top cross-sectional view of a principal part showing a structure of the mirror protecting section and the half mirror. FIGS. 2A through 2C show the right side of the head mounted display 1. The head mounted display 1 is roughly bilaterally symmetric, and the left side of the head mounted display 1 has substantially the same shape as the shape of the right side. As shown in FIGS. 2A and 2B, the drawing device 7 emits a laser beam 18 toward the half mirror 3. The laser beam 18 emitted is reflected by the half mirror 3, and an eyeball 2c of the human head 2 is irradiated with the laser beam 18. The drawing device 7 and the half mirror 3 form a virtual image corresponding to the video signal, and the observer 21 can appreciate a picture by viewing the virtual image.

The half mirror 3 and the drawing device 7 are connected to each other with a connection section 22 as a moving section. The connection section 22 is formed of a material having flexibility, and as the material of the connection section 22, there is used metal or resin. In the case of using metal as the material of the connection section 22, it is preferable to thin the metal. It is possible to reduce the stress necessary for deforming the connection section 22 to inhibit the fatigue failure of the connection section 22. As shown in FIG. 2C, a hollow 23 extending in the horizontal direction 8b is disposed inside the mirror protecting section 5, and the half mirror 3 is disposed in the hollow 23. In the mirror protecting section 5, there are disposed a first window section 5a as a window section, and a second window section 5b as a window section across the hollow 23 from each other. The first window section 5a and the second window section 5b are each made as a light transmissive plate-like member.

The half mirror 3 is made semi-transparent. The first window section 5a and the second window section 5b are disposed across the half mirror 3 from each other. Therefore, a part of light 24 passing through the first window section 5a and the second window section 5b proceeds while passing through the half mirror 3, and then passing through the first window section 5a and the second window section 5b. Therefore, it is possible for the observer 21 to receive the light passing through the first window section 5a, the second window section 5b, and the half mirror 3. Thus, it is possible for the observer 21 to receive light 24 and the laser beam 18 passing through the mirror protecting section 5.

The first window section 5a is located on the human head 2 side with respect to the hollow 23, and the second window section 5b is located on the opposite side of the hollow 23 to the first window section 5a. Due to the first window section 5a and the second window section 5b, the observer 21 is prevented from having contact with the half mirror 3. Thus, it is possible to prevent the observer 21 from having contact with the half mirror 3 to be scraped. Further, it is possible to prevent the half mirror 3 from being contaminated with grit and dust.

The half mirror 3 is provided with a plate-like member 3a as a plate, and in the plate-like member 3a, a concave surface 3b is disposed on the surface located on the side facing to the human head 2. A hologram sheet 25 is disposed on the concave surface 3b. The hologram sheet 25 diffracts the laser beam 18 to thereby change the proceeding direction of the laser beam 18. Therefore, the concave surface 3b of the half mirror 3 can be made shallow. Also in the case in which the hologram sheet 25 is irradiated with the laser beam 18, it is possible to conduct the heat of the hologram sheet 25 to the plate-like member 3a of the half mirror 3 to thereby suppress rise in temperature. The plate-like member 3a is made of glass, and has heat resistance. Therefore, even in the case in which the plate-like member 3a is irradiated with the laser beam 18, it is possible to inhibit the plate-like member 3a from deforming.

The half mirror 3 is arranged to be movable in the hollow 23 along the first window section 5a and the second window section 5b in the horizontal direction 8b. The half mirror 3 is connected to the drawing device 7 with the connection section 22. When the stage 9 moves the drawing device 7, the half mirror 3 moves in conjunction with the drawing device 7. Therefore, the stage 9 moves the drawing device 7 and the half mirror 3 in conjunction with each other.

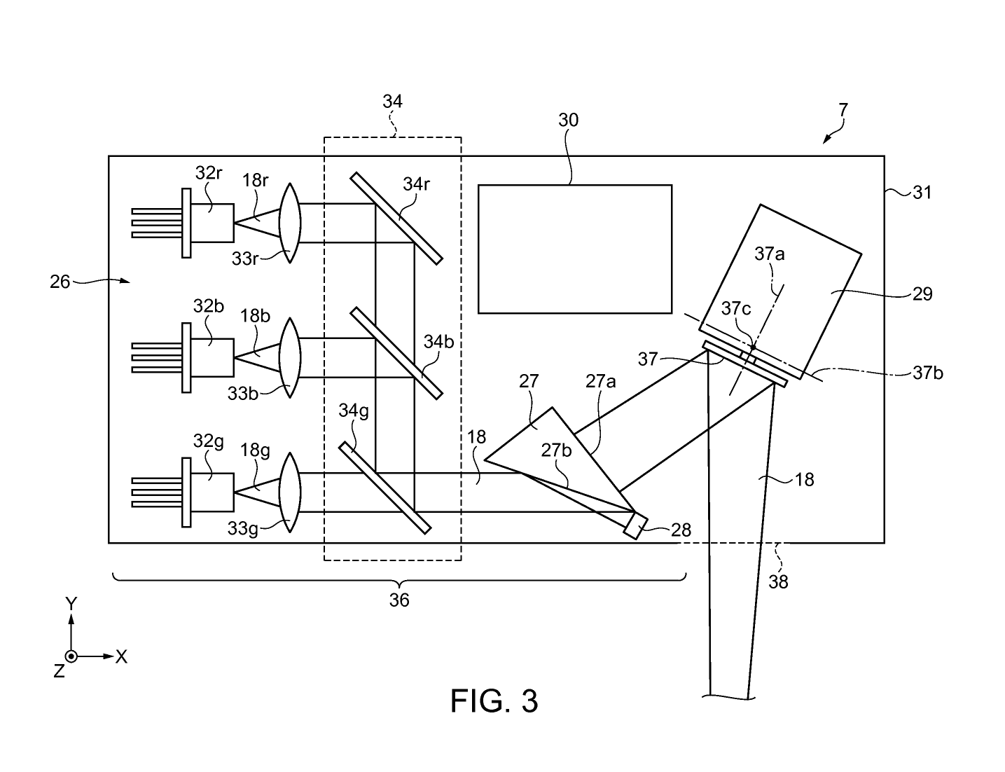

Then, the drawing device 7 will be explained. FIG. 3 is a block diagram showing a configuration of a projector section. As shown in FIG. 3, there are shown an X axis, a Y axis, and a Z axis as three axes perpendicular to each other, and the tip side of each of the arrows shown in the drawing is defined as “+ side,” and the base end side is defined as “− side” for the sake of convenience of explanation. Further, a direction parallel to the X axis is referred to as an “X-axis direction,” a direction parallel to the Y axis is referred to as a “Y-axis direction,” and a direction parallel to the Z axis is referred to as a “Z-axis direction.” A plane parallel to both of the X axis and the Y axis is referred to as an “X-Y plane.”

The drawing device 7 is provided with a light source unit 26 for emitting the laser beam 18. The laser beam 18 emitted by the light source unit 26 is output to a prism 27. The prism 27 tilts the optical axis of the laser beam 18, and at the same time deforms the cross-sectional shape of the laser beam. The prism 27 is provided with a detection section 28 for detecting the intensity of the laser beam 18. The laser beam 18 having passed through the prism 27 is output to a drawing section 29. The drawing section 29 performs scanning with the laser beam 18. The drawing device 7 is provided with a drawing control section 30, and the drawing control section 30 controls actions of the light source unit 26 and the drawing section 29. The constituents of the drawing device 7 are housed in a housing 31. Therefore, the drawing section 29 is incorporated in the drawing device 7.

The light source unit 26 is provided with a red light source 32r, a blue light source 32b, and a green light source 32g. The red light source 32r, the blue light source 32b, and the green light source 32g emit a red laser beam 18r, a blue laser beam 18b, and a green laser beam 18g, respectively.

On the optical axes of the red light source 32r, the blue light source 32b, and the green light source 32g, there are disposed a red-light lens 33r, a blue-light lens 33b, and a green-light lens 33g, respectively. The red-light lens 33r, the blue-light lens 33b, and the green-light lens 33g are each a collimator lens, and convert the red laser beam. 18r, the blue laser beam 18b, and the green laser beam 18g into parallel light beams or roughly parallel light beams, respectively. On the optical axes of the red-light lens 33r, the blue-light lens 33b, and the green-light lens 33g, there are disposed a red-light mirror 34r, a blue-light mirror 34b, and a green-light mirror 34g, respectively. The red-light mirror 34r, the blue-light mirror 34b, and the green-light mirror 34g are each a dichroic mirror.

As the red light source 32r, the blue light source 32b, and the green light source 32g, there can be used a semiconductor laser such as an edge emission semiconductor laser or a surface emission semiconductor laser. By using the semiconductor lasers, the red light source 32r, the blue light source 32b, and the green light source 32g can be made small in size.

The red-light mirror 34r, the blue-light mirror 34b, and the green-light mirror 34g constitute a light combining section 34. The red-light mirror 34r reflects the red laser beam 18r. The blue-light mirror 34b reflects the blue laser beam 18b, and at the same time transmits the red laser beam 18r. The green-light mirror 34g has a property of transmitting the green laser beam 18g, and at the same time reflecting the red laser beam 18r and the blue laser beam 18b. The red-light mirror 34r, the blue-light mirror 34b, and the green-light mirror 34g combine the red laser beam 18r, the blue laser beam 18b, and the green laser beam 18g with each other so that the optical axes coincide or roughly coincide with each other, and the single laser beam 18 is emitted in the +X-axis direction.

The prism 27 has a first function of tilting the optical axis of the laser beam 18, a second function of deforming the cross-sectional shape of the laser beam 18, and a third function of controlling a radiation angle of the laser beam 18. The prism 27 is a substantially colorless and transparent polyhedron formed of glass or quartz crystal. Such a prism 27 is not particularly limited providing such functions as described above are provided, and a triangular prism roughly shaped like a triangle pole, for example, can be used.

The prism 27 shapes the cross-sectional shape perpendicular to the optical axis of the laser beam 18 from a roughly elliptical shape to a roughly circular shape. The prism 27 shapes the cross-sectional shape of the laser beam 18 having entered the prism 27 to a roughly circular shape by increasing the width in an in-plane direction of the X-Y plane while keeping the width in the Z-axis direction roughly constant in the cross-sectional shape of the laser beam 18. In other words, the prism 27 increases the length of the short axis of the ellipse as the cross-sectional shape to thereby shape the cross-sectional shape of the laser beam 18 so that the ratio (aspect ratio) between the short axis and the long axis becomes roughly 1. As described above, by shaping the cross-sectional shape of the laser beam 18 to a roughly circular shape, the drawing device 7 capable of exerting an excellent image display characteristic is obtained.

An emission surface 27a of the prism 27 is formed of a curved convex surface, and functions as a collecting lens to converge the laser beam 18 having entered the prism 27 as a parallel light beam. By converging the laser beam 18 in such a manner as described above, a clearer image provoking a feeling of high-resolution can be displayed.

On one end of the prism 27, there is disposed the detection section 28. A plane of incidence 27b of the prism 27 is configured so as to slightly reflect the laser beam 18 (e.g., a reflectance of about 0.1%), and the detection section 28 is located on the optical path of the reflected light beam. The detection section 28 has a function of detecting the intensity of the laser beam 18. Such a detection section 28 has a photosensitive element such as a photodiode. A signal (a voltage) with the level corresponding to the light intensity of the reflected light beam thus received is output from the photosensitive element, and the light intensity of each of the red laser beam 18r, the blue laser beam 18b, and the green laser beam 18g can be detected based on the signal. The part from the red light source 32r, the blue light source 32b, and the green light source 32g to the prism 27 is referred to as a light source section 36.

The information related to the light intensities of the red laser beam 18r, the blue laser beam 18b, and the green laser beam 18g having been detected by the detection section 28 is transmitted to the drawing control section 30. The drawing control section 30 controls the drive of the red light source 32r, the blue light source 32b, and the green light source 32g based on the information received.

The drawing section 29 has a function of performing two-dimensional scan with the laser beam 18 having passed through the prism 27. Such a drawing section 29 is not particularly limited providing the two-dimensional scan with the laser beam 18 can be performed. The drawing section 29 has a light reflecting surface 37 as a mirror for reflecting the laser beam 18. An axis in the normal direction of the light reflecting surface 37 is referred to as a first axis 37a, and two axes perpendicular to each other in tangential directions of the light reflecting surface 37 are referred to as a second axis 37b and a third axis 37c. In the drawing section 29, the light reflecting surface 37 oscillates around the second axis 37b and the third axis 37c. The drawing section 29 reflects the laser beam 18 with the light reflecting surface 37, and rotates the light reflecting surface 37 to thereby draw an image.

The housing 31 is provided with a window section 38 having a light transmissive property. The window section 38 is formed of a transparent material such as glass or plastic. Through the window section 38, the laser beam 18 moved by the drawing section 29 so as to perform the two-dimensional scan is emitted to the outside of the housing 31.

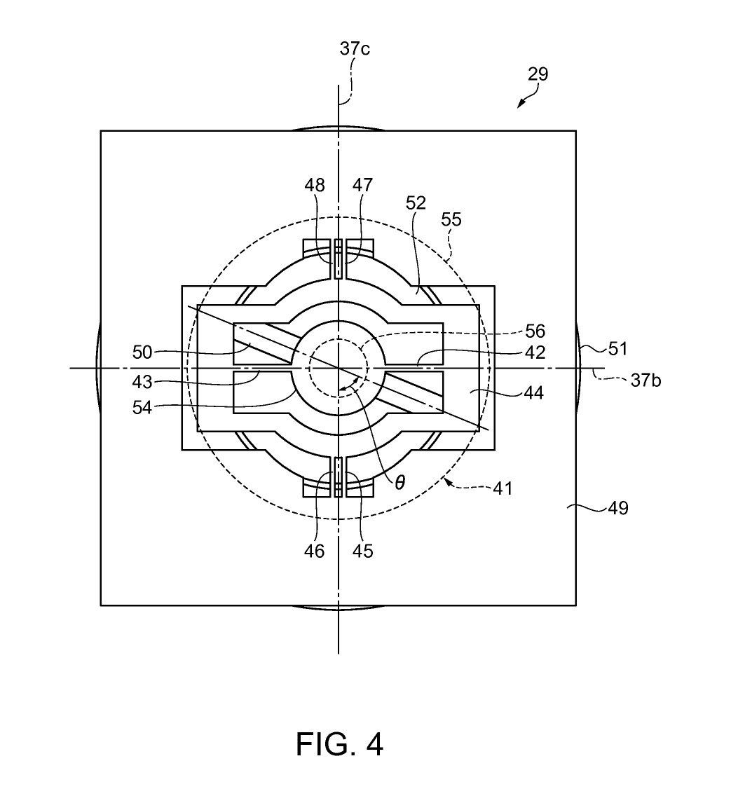

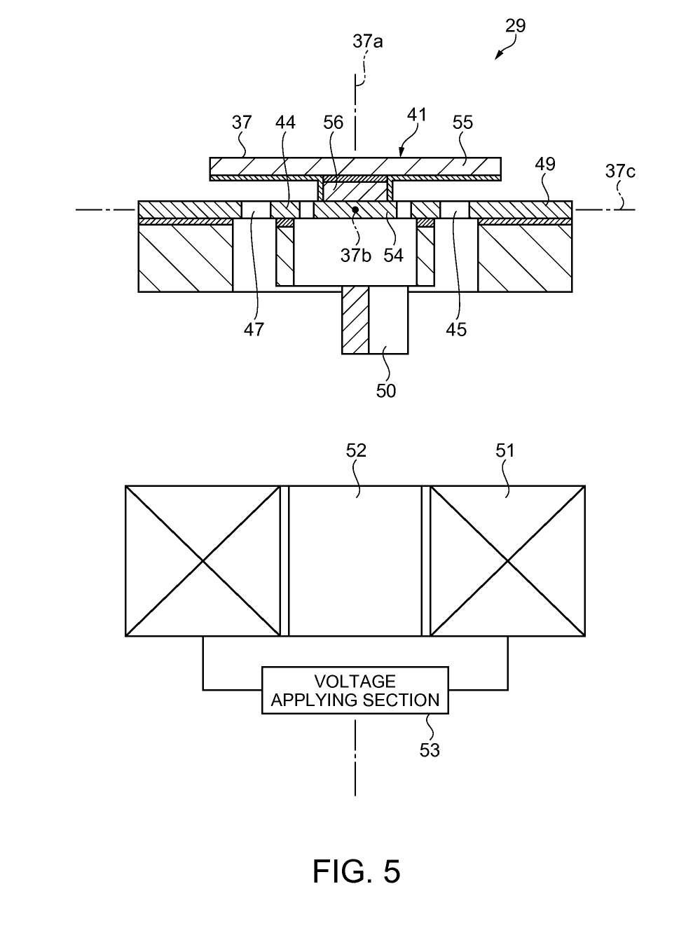

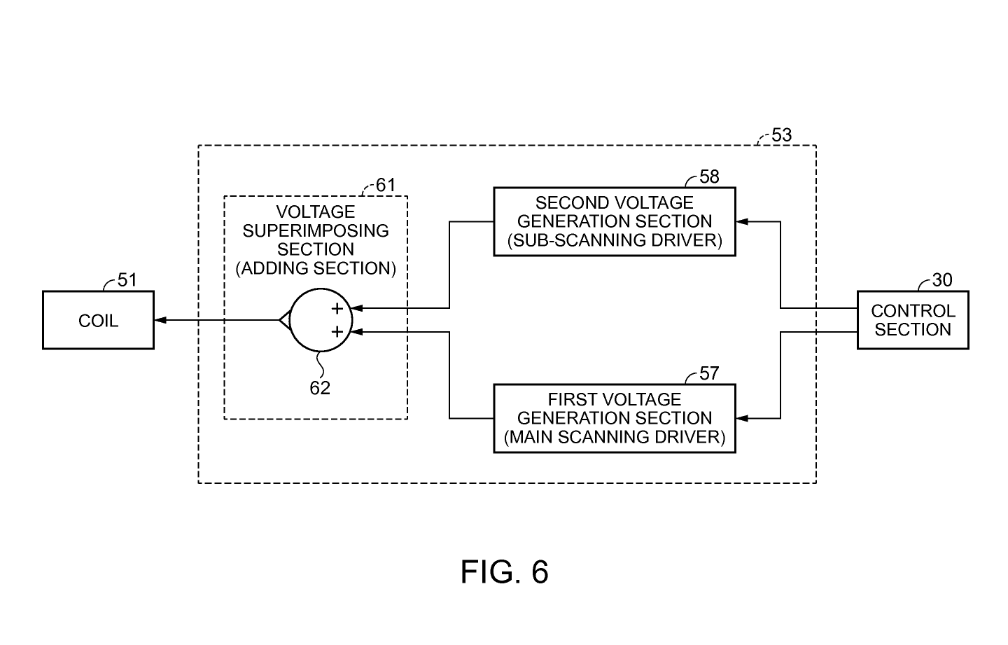

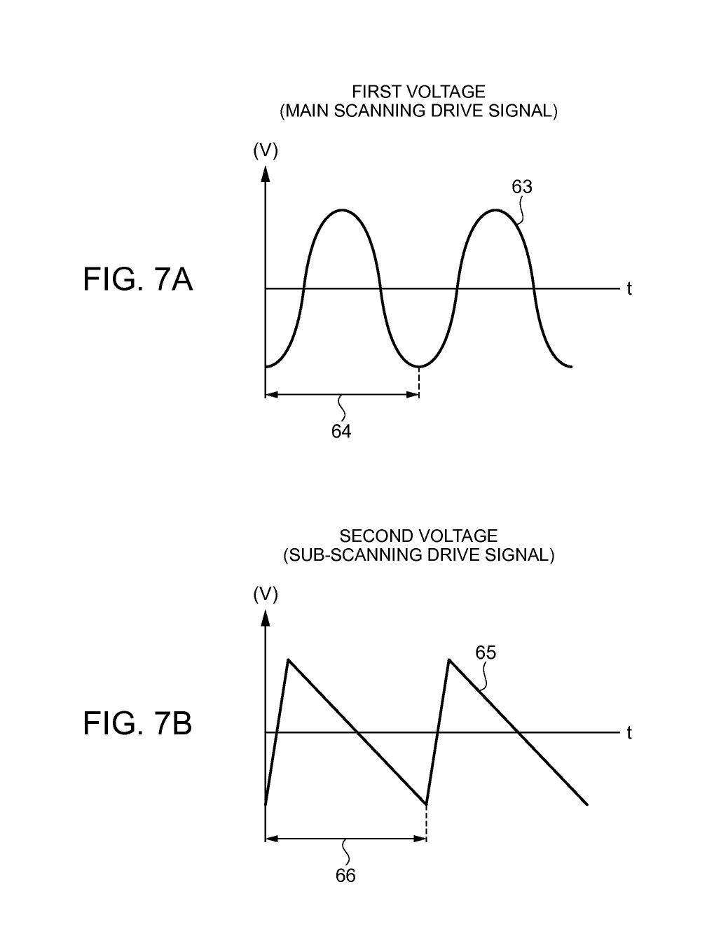

Then, the drawing section 29 will be explained. FIG. 4 is a plan view showing a light scanning section provided to the drawing section, and FIG. 5 is a side cross-sectional view of the light scanning section. FIG. 6 is a block diagram of a voltage applying section. FIGS. 7A and 7B are diagrams for explaining a voltage generated by a voltage generation section.

As shown in FIGS. 4 and 5, the drawing section 29 is provided with a movable section 41, and a pair of shaft sections 42, 43 (first shaft sections). Further, the drawing section 29 is provided with a frame body section 44, two pairs of shaft sections 45, 46, 47, and 48 (second shaft sections), and a support section 49. Further, the drawing section 29 is provided with a permanent magnet 50, a coil 51, a magnetic core 52, and a voltage applying section 53.

The movable section 41 and the pair of shaft sections 42, 43 constitute a first vibration system oscillating (rotating in both directions) around the second axis 37b. The movable section 41, the pair of shaft sections 42, 43, the frame body section 44, the two pairs of shaft sections 45, 46, 47, and 48, and the permanent magnet 50 constitute a second vibration system oscillating (rotating in both directions) around the third axis 37c. The permanent magnet 50, the coil 51, and the voltage applying section 53 constitute a drive section for driving the first vibration system and the second vibration system.

The movable section 41 includes a base section 54, and a light reflecting plate 55 fixed to the base section 54. On the upper surface of the light reflecting plate 55, there is disposed the light reflecting surface 37 having a light reflecting property. The light reflecting surface 37 reflects the laser beam 18. As described above, the movable section 41 oscillates around the second axis 37b and the third axis 37c. Therefore, the base section 54, the light reflecting plate 55, and the light reflecting surface 37 constituting the movable section 41 also oscillate around the second axis 37b and the third axis 37c.

A lower surface of the light reflecting plate 55 is fixed to the base section 54 via a spacer 56. Thus, it is possible to oscillate the light reflecting plate 55 around the second axis 37b while preventing the light reflecting plate 55 from having contact with the shaft sections 42, 43, the frame body section 44, and the shaft sections 45 through 48.

The frame body section 44 has a frame-like shape, and is disposed so as to surround the base section 54 of the movable section 41 described above. In other words, the base section 54 of the movable section 41 is disposed inside the frame body section 44 having a frame-like shape. The frame body section 44 is supported by the support section 49 via the shaft sections 45 through 48. The base section 54 of the movable section 41 is supported by the frame body section 44 via the shaft sections 42, 43.

The shaft sections 42, 43 and the shaft sections 45 through 48 are each elastically deformable. The shaft sections 42, 43 connect the movable section 41 and the frame body section 44 to each other so that the movable section 41 can oscillate around the second axis 37b. The shaft sections 45 through 48 connect the frame body section 44 and the support section 49 to each other so that the frame body section 44 can oscillate around the third axis 37c perpendicular to the second axis 37b.

The shaft sections 42, 43 are disposed at places across the base section 54 of the movable section 41 from each other. The shaft sections 42, 43 each have an elongated shape extending in a direction along the second axis 37b. The shaft sections 42, 43 each have one end portion connected to the base section 54, and the other end portion connected to the frame body section 44. The shaft sections 42, 43 are each disposed so that the center axis coincides with the second axis 37b. Such shaft sections 42, 43 are each torsionally deformed due to the oscillating movement around the second axis 37b.

The shaft sections 45 through 48 are disposed at places across the frame body section 44 from each other. The shaft sections 45 through 48 each have an elongated shape extending in a direction along the third axis 37c. The shaft sections 45 through 48 each have one end portion connected to the frame body section 44, and the other end portion connected to the support section 49. The shaft sections 45, 46 are disposed so as to be opposed to each other via the third axis 37c, and similarly, the shaft sections 47, 48 are disposed so as to be opposed to each other via the third axis 37c. Among such shaft sections 45 through 48, the pair of the shaft sections 45, 46 and the pair of the shaft sections 47, 48 each torsionally deform due to the oscillation of the frame section 44 around the third axis 37c.

As described above, by making the movable section 41 capable of oscillating around the second axis 37b and making the frame body section 44 capable of oscillating around the third axis 37c, it is possible to make the light reflecting plate 55 oscillate around the two axes, namely the second axis 37b and the third axis 37c, perpendicular to each other.

To the lower surface of the frame body section 44, there is bonded the permanent magnet 50. The permanent magnet 50 is magnetized in a direction oblique to both of the second axis 37b and the third axis 37c in a planar view. The permanent magnet 50 forms an elongated shape (a rod-like shape) extending in the direction oblique to both of the second axis 37b and the third axis 37c. The permanent magnet 50 is magnetized in the longitudinal direction thereof. In other words, the permanent magnet 50 is magnetized so that one end portion is the south pole, and the other end portion is the north pole. The permanent magnet 50 is disposed so as to be symmetric about the intersection between the second axis 37b and the third axis 37c in the planar view.

The tilt angle θ of the magnetization direction (the extending direction) of the permanent magnet 50 with respect to the third axis 37c is preferably no smaller than 30° and no larger than 60°. By disposing the permanent magnet 50 in such a manner, the movable section 41 can smoothly and reliably be rotated around the third axis 37c. As the permanent magnet 50, a neodymium magnet, a ferrite magnet, a samarium-cobalt magnet, an alnico magnet, a bond magnet, for example, can preferably be used. The permanent magnet 50 is obtained by magnetizing a hard magnetic material.

The coil 51 is disposed immediately beneath the permanent magnet 50. Thus, it is possible to make the magnetic field generated by the coil 51 efficiently act on the permanent magnet 50. The coil 51 is disposed so as to be wound around the magnetic core 52. Thus, it is possible to make the magnetic field generated by the coil 51 efficiently act on the permanent magnet 50. The coil 51 is electrically connected to the voltage applying section 53. By the voltage applying section 53 applying a voltage to the coil 51, the magnetic field having a flux perpendicular to the second axis 37b and the third axis 37c is generated from the coil 51.

As shown in FIG. 6, the voltage applying section 53 is provided with a first voltage generation section 57 for generating a first voltage for rotating the movable section 41 around the second axis 37b, a second voltage generation section 58 for generating a second voltage for rotating the movable section 41 around the third axis 37c, and a voltage superimposing section 61 for superimposing the first voltage and the second voltage on each other, and applies the voltage, which is obtained by the superimposition in the voltage superimposing section 61, to the coil 51.

The voltage superimposing section 61 is provided with an adder 62 for applying the voltage to the coil 51. The adder 62 receives the first voltage from the first voltage generation section 57, and at the same time, receives the second voltage from the second voltage generation section 58, and then superimposes these voltages on each other to apply the result to the coil 51.

In FIG. 7A, the vertical axis represents the first voltage, wherein the upper side is higher in voltage than the lower side in the drawing. The horizontal axis represents the passage of time. A first voltage waveform 63 represents a voltage waveform output by the first voltage generation section 57. As represented by the first voltage waveform 63, the first voltage generation section 57 generates the first voltage (main scanning voltage) periodically varying with a first period 64. The first voltage has a waveform like a sinusoidal wave. The frequency of the first voltage is preferably in a range of, for example, 10 through 40 kHz. The frequency of the first voltage is set to be equal to the torsional resonant frequency of the first vibration system constituted by the movable section 41, and the pair of shaft sections 42, 43. Thus, the rotational angle of the movable section 41 around the second axis 37b can be increased.

In FIG. 7B, the vertical axis represents the second voltage, wherein the upper side is higher in voltage than the lower side in the drawing. The horizontal axis represents the passage of time. A second voltage waveform 65 represents a voltage waveform output by the second voltage generation section 58. As represented by the second voltage waveform 65, the second voltage generation section 58 generates the second voltage (sub-scanning voltage) periodically varying with a second period 66 different from the first period 64. The second voltage 65 forms a waveform like a sawtooth wave. The frequency of the second voltage waveform 65 is only required to be different from the frequency of the first voltage waveform 63, and is preferably in a range of, for example, 30 through 80 Hz (around 60 Hz). In the present embodiment, the frequency of the second voltage waveform 65 is adjusted to be a frequency different from the torsional resonant frequency (resonant frequency) of the second vibration system constituted by the movable section 41, the pair of shaft sections 42, 43, the frame body section 44, the two pairs of shaft sections 45 through 48, and the permanent magnet 50.

Such a frequency of the second voltage is preferably lower than the frequency of the first voltage. Thus, the movable section 41 can more reliably and smoothly be oscillated around the third axis 37c at the frequency of the second voltage while being oscillated around the second axis 37b at the frequency of the first voltage. The drawing control section 30 also performs drive of the drawing section 29 in addition to the control of the light source section 36.

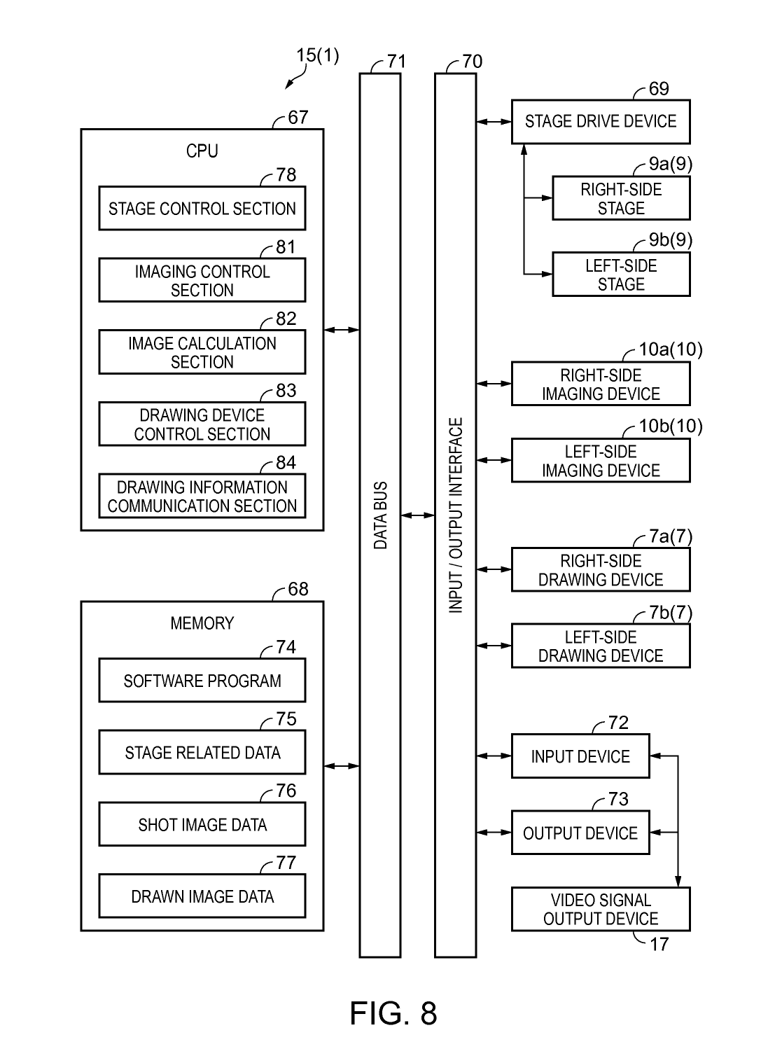

FIG. 8 is an electrical control block diagram of the head mounted display. In FIG. 8, the head mounted display 1 is provided with the control section 15 for controlling the operation of the head mounted display 1. The control section 15 is provided with a central processing unit (CPU) 67 for performing a variety of arithmetic processing as a processor, and a memory 68 for storing a variety of types of information. A stage drive device 69, the right-side imaging device 10a, and the left-side imaging device 10b are connected to the CPU 67 via an input/output interface 70 and a data bus 71. Further, the right-side drawing device 7a, the left-side drawing device 7b, input devices 72, and output devices 73 are also connected to the CPU 67 via the input/output interface 70 and the data bus 71.

The stage drive device 69 is a device for driving the right-side stage 9a and the left-side stage 9b. The stage drive device 69 receives an instruction signal from the CPU 67, and then drives to move the stages 9 formed of the right-side stage 9a and the left-side stage 9b to the state thus instructed. In each of the stages 9, there is installed a position detection device for detecting the position of the movable table. The stage drive device 69 drives the position detection devices to detect the positions of the movable tables of the right-side stage 9a and the left-side stage 9b, respectively. The drawing device 7 is connected to the movable table, and the drawing device 7 and the half mirror 3 are connected to each other with the connection section 22. Therefore, the stage drive device 69 can detect the positions of the drawing device 7 and the half mirror 3.

The imaging devices 10 formed of the right-side imaging device 10a and the left-side imaging device 10b are each provided with an area sensor formed of a solid-state imaging element or the like disposed inside, and are each arranged to be able to convert an image taken by the area sensor into an electric signal and then output the electric signal. The solid-state imaging element accumulates the charge in accordance with the luminance of the light received and the time for which the light is received to thereby output the luminance of the light as a voltage signal. The imaging devices 10 each receive an instruction signal from the CPU 67, and then perform shooting in accordance with the instruction signal. The data of the image thus shot is transmitted to the memory 68.

The input devices 72 include a device for performing wired and wireless communication with the video signal output device 17 in addition to a power switch and a switch for an operation. A variety of types of data is input to the memory 68 using these input devices 72.

The output devices 73 include a speaker and a device for performing wired and wireless communication with the video signal output device 17 in addition to a liquid crystal display device. Thus, the control section 15 is arranged to be able to display and output the state of the head mounted display 1 and the setting state set by the observer 21.

The memory 68 is a conceptual representation including a semiconductor memory such as a RAM or a ROM, and a peripheral storage device such as a hard drive or a DVD-ROM. In view of the function, there are set a storage area for storing a software program 74 describing a control procedure of the operation of the head mounted display 1, and a storage area for storing stage related data 75 as the data used when calculating the moving amount of the stages 9. Besides the above, there is set a storage area for storing shot image data 76 as the data related to the image shot by the imaging device 10. Besides the above, there is set a storage area for storing drawn image data 77 as image data drawn by the drawing device 7. Besides the above, there are set a storage area functioning as a work area or a temporary file for the CPU 67 and a variety of types of storage areas.

The CPU 67 is for performing control of projecting a virtual image on the half mirror 3 in accordance with the software program 74 stored in the memory 68. As a specific function realizing section, the CPU 67 includes a state control section 78. The stage control section 78 outputs an instruction signal to the state drive device 69 to perform control of driving the stages 9 to move the drawing devices 7 and the half mirrors 3.

Besides the above, the CPU 67 includes an imaging control section 81. The imaging control section 81 outputs an instruction signal for performing shooting to the imaging devices 10 to perform the control of making the imaging devices 10 shoot the eyeballs 2c. The imaging devices 10 store the images thus shot to the memory 68. Besides the above, the CPU includes an image calculation section 82. The image calculation section 82 inputs the shot image data 76 including the eyeballs 2c thus shot from the memory 68. The direction of a visual line of the observer 21 is calculated using the shot image data 76. The imaging control section 81, the image calculation section 82, and the imaging devices 10 constitute a visual line detection section.

Besides the above, the CPU 67 includes a drawing device control section 83. The drawing device control section 83 inputs the drawn image data 77 from the memory 68. The drawn image data 77 and an instruction signal of starting or stopping drawing are transferred to the drawing devices 7.

Besides the above, the CPU 67 includes a drawing information communication section 84. The drawing information communication section 84 performs communication with the video signal output device 17 to receive the drawn image data 77. The drawing information communication section 84 stores the drawn image data 77 in the memory 68. In the present embodiment, it is assumed that the functions described above are realized by the software programs using the CPU 67. However, in the case in which each of the functions described above can be realized by an independent electronic circuit (hardware) not using the CPU 67, it is also possible to use such an electronic circuit.

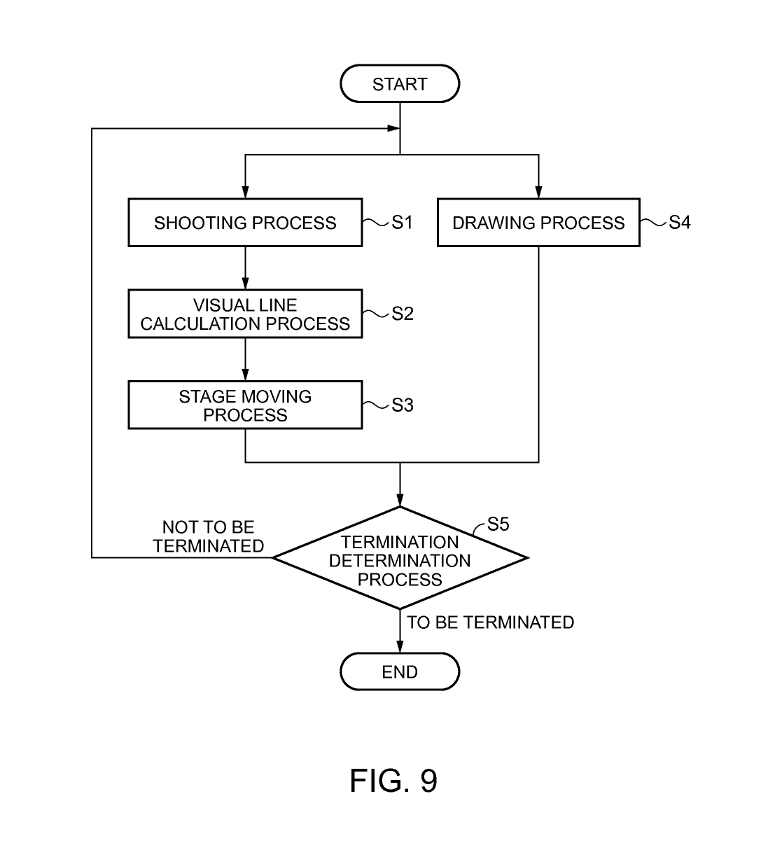

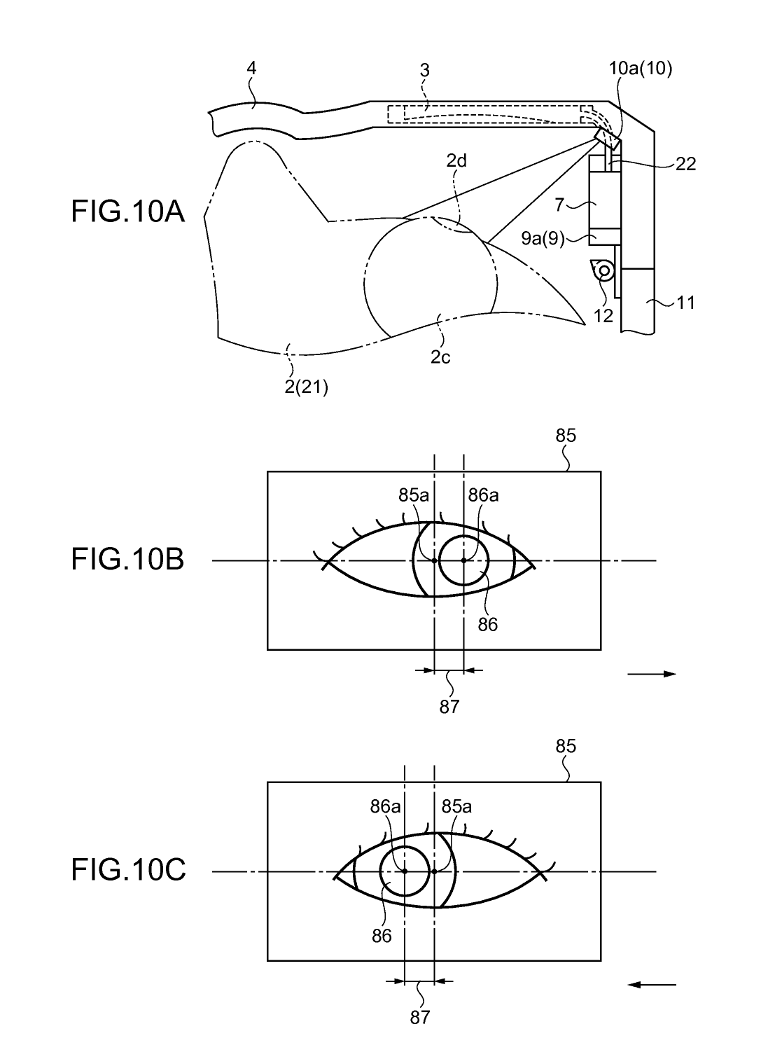

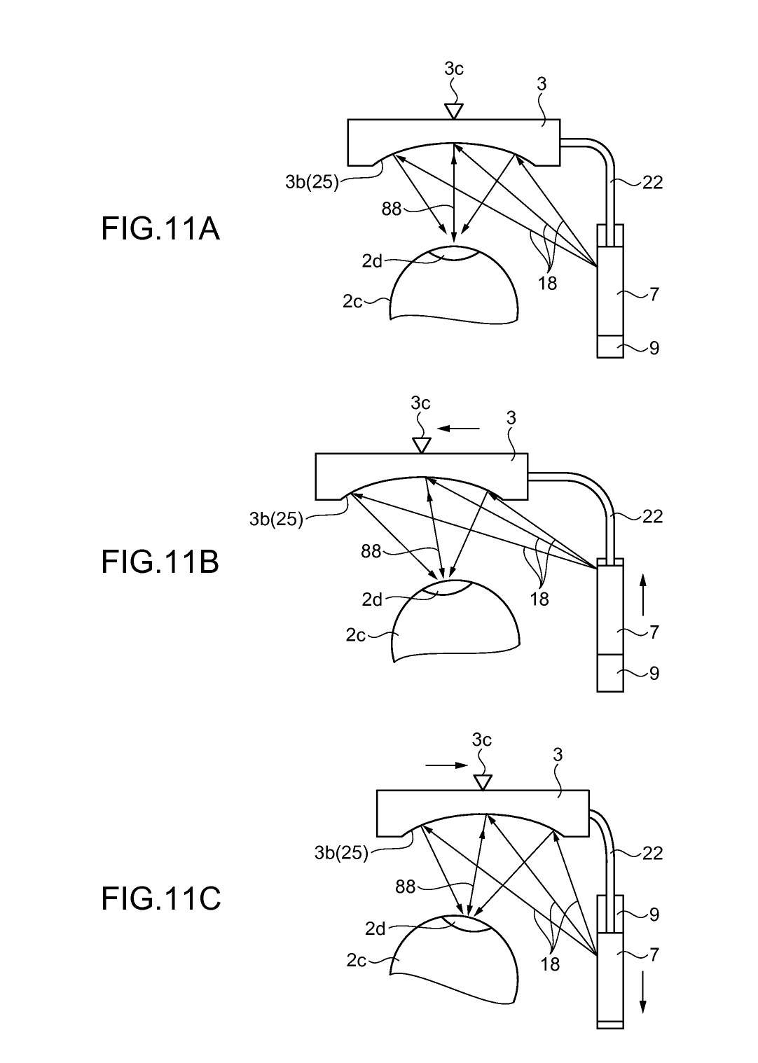

Then, a drawing method for drawing the virtual image on the half mirror 3 using the head mounted display 1 described above will be explained with reference to FIGS. 9 through 11C. FIG. 9 is a flowchart showing the drawing method. FIGS. 10A through 11C are schematic diagrams for explaining the drawing method. In the flowchart shown in FIG. 9, the step S1 corresponds to a shooting process, and is a process in which the imaging devices 10 shoot the eyeballs 2c. Then, the process proceeds to the step S2. The step S2 corresponds to a visual line calculation process. This process is a process of calculating the places where the visual lines of the observer 21 intersect with the half mirrors 3, respectively. Then, the process proceeds to the step S3. The step S3 corresponds to a stage moving process. This process is a process in which the stages 9 move the drawing devices 7 and the half mirrors 3, respectively. Then, the process proceeds to the step S5. The step S4 corresponds to a drawing process. This process is a process in which the drawing devices 7 form virtual images on the half mirrors 3, respectively. Then, the process proceeds to the step S5. The steps S1 through S3 and the step S4 are performed in parallel to each other. The step S5 corresponds to a termination determination process. In the case in which drawing will not be terminated, the process proceeds to the steps S1 and S4. In the case in which drawing will be terminated, the drive of the head mounted display 1 is terminated. Through the processes described hereinabove, drawing is complete.

Then, the drawing method will be explained in detail using FIGS. 10A through 11C so as to correspond to the steps shown in FIG. 9. FIG. 10A is a diagram corresponding to the shooting process of the step S1. As shown in FIG. 10A, the imaging devices 10 shoot the eyeballs 2c. The right side imaging device 10a shoots the right eye, and the left side imaging device 10b shoots the left eye. The shapes of the white part of an eye, the black eye, and the pupil 2d of each of the eyeballs 2c are shot. The imaging control section 81 outputs the instruction signal for performing shooting to the imaging devices 10. The imaging devices 10 receive the instruction signal to shoot the eyeballs 2c, and then store the result in the memory 68 as the shot image data 76.

FIGS. 10B and 10C are diagrams corresponding to the visual line calculation process of the step S2. FIG. 10B shows the case in which the observer 21 sets the visual line to the right side in the drawing. The image calculation section 82 calculates a distance 87 between an image center 85a as the center of the image 85 and a pupil center 86a as the center of the image 86 of the pupil. It is also possible to calculate the centroid of the image 86 of the pupil to use the result as the pupil center 86a in the calculation of the pupil center 86a. It is also possible to calculate the pupil center 86a using a boundary line between the white part of the eye and the black eye.

The stage related data 75 includes a data table showing a relationship between the position where the visual line of the pupil 2d intersects with the half mirror 3 and the distance 87. The image calculation section 82 calculates the position where the visual line intersects with the half mirror 3 using the data table, the data of the distance 87, and the information that the image 86 of the pupil is shifted rightward.

FIG. 10C shows the case in which the observer 21 sets the visual line to the left side in the drawing. In this case, the image calculation section 82 also calculates the distance 87 in a similar manner. The image calculation section 82 calculates the position where the visual line intersects with the half mirror 3 using the data table, the data of the distance 87, and the information that the image 86 of the pupil is shifted leftward.

FIGS. 11A through 11C are diagrams corresponding to the stage moving process of the step S3 and the drawing process of the step S4. As shown in FIG. 11A, in the case in which the pupil 2d faces to the front, the visual line 88 proceeds toward the front of the human head 2. An optimum point 3c is set to the half mirror 3, and the concave surface 3b and the hologram sheet 25 are formed so that an optimum image can be observed in the case in which the optimum point 3c is located on the visual line 88. In the step S3, the stage control section 78 controls the stage 9 so that the optimum point 3c overlaps the position where the visual line 88 intersects with the half mirror 3. In the step S4, the drawing device 7 emits the laser beam 18. On this occasion, the observer 21 can observe a clear virtual image.

As shown in FIG. 11B, in the case in which the pupil 2d faces to the left side in the drawing, the visual line 88 proceeds toward the left side of the human head 2. In the step S1, the imaging device 10 shoots the pupil 2d, and in the step S2, the image calculation section 82 calculates the position where the visual line 88 intersects with the half mirror 3. In the step S3, the stage control section 78 detects the position of the movable table of the stage 9 via the stage drive device 69. The movable table is connected to the half mirror 3 via the drawing device 7 and the connection section 22. The stage related data 75 includes the data of the position of the optimum point 3c with respect to the position of the movable table. The stage control section 78 calculates the position of the optimum point 3c from the stage related data 75 and the position information of the movable table.

Then, the stage control section 78 controls the stage 9 so that the optimum point 3c overlaps the position where the visual line 88 intersects with the half mirror 3. As a result, since the optimum point 3c is located on the visual line 88, when the drawing device 7 emits the laser beam 18 in the step S4, the observer 21 can observe a clear virtual image.

As shown in FIG. 11C, in the case in which the pupil 2d faces to the right side in the drawing, the visual line 88 proceeds toward the right side of the human head 2. On this occasion, the stage control section 78 also drives the stage 9 so that the optimum point 3c overlaps the position where the visual line 88 intersects with the half mirror 3. As a result, since the optimum point 3c is located on the visual line 88, when the drawing device 7 emits the laser beam 18 in the step S4, the observer 21 can observe a clear virtual image.

In the case in which the observer 21 moves the visual line 88 in the horizontal direction, the imaging control section 81 and the image calculation section 82 detect the direction of the visual line 88. The stage control section 78 controls the position of the half mirror 3 so that the optimum point 3c is located on the visual line 88. On this occasion, the position of the drawing device 7 is also controlled together with the half mirror 3. Thus, the drawing device 7 emits the laser beam 18 from the position where the laser beam 18 reflected by the half mirror 3 passes through the pupil 2d. Therefore, the observer 21 can observe a clear virtual image.

As described above, according to the present embodiment, the following advantages are obtained. (1) According to the present embodiment, in the case in which the observer 21 observing a virtual image moves the visual line 88, the imaging devices 10, the imaging control section 81, and the image calculation section 82 detect the visual line 88 of the observer 21. The control section 15 controls the stages 9, and each of the stages 9 moves the drawing device 7 and the half mirror 3 in conjunction with each other. Thus, it is possible to move the virtual image in accordance with the motion of the visual line 88 of the observer 21. It is possible for the head mounted display 1 to project the virtual image so that the laser beam 18 passes through the pupil 2d of the observer 21. Therefore, it is possible for the head mounted display 1 to display a clear image in accordance with the visual line 88 of the observer 21.

(2) According to the present embodiment, the connection section 22 connects the drawing device 7 and the half mirror 3 to each other. Due to the connection section 22, the drawing device 7 and the half mirror 3 move in conjunction with each other in a predetermined positional relationship. Therefore, by moving the drawing device 7, the stage 9 can move the half mirror 3 in conjunction with the drawing device 7. As a result, it is possible to adopt a simpler structure compared to the case in which the stage 9 moves the drawing device 7 and the half mirror 3 separately from each other.

(3) According to the present embodiment, the half mirror 3 is disposed in the mirror protecting section 5. In the mirror protecting section 5, the first window section 5a and the second window section 5b both having a light transmissive property are disposed so as to be opposed to each other. The half mirror 3 is irradiated with the laser beam 18 through the first window section 5a, and the half mirror 3 can forma virtual image. In the case in which the half mirror 3 is moved by the stage 9, the half mirror 3 is disposed in the mirror protecting section 5 and is protected by the mirror protecting section 5. Therefore, it is possible to prevent the half mirror 3 from having contact with the observer 21 to be scraped.

(4) According to the present embodiment, the half mirror 3 has the plate-like member 3a on which the hologram sheet 25 is disposed. The hologram sheet 25 diffracts the laser beam 18 to thereby change the proceeding direction of the laser beam 18. Therefore, the concavity and convexity of the plate-like member 3a can be made shallow. Also in the case in which the hologram sheet 25 is irradiated with the laser beam 18, it is possible to conduct the heat of the hologram sheet 25 to the plate-like member 3a to thereby suppress rise in temperature.

(5) According to the present embodiment, the first window section 5a and the second window section 5b are disposed across the half mirror 3 from each other. Therefore, it is possible for a part of the light 24 passing through the second window section 5b to proceed through the half mirror 3 and then further proceed through the first window section 5a. Therefore, it is possible for the observer 21 to receive the light 24 passing through the first window section 5a, the second window section 5b, and the half mirror 3. As a result, it is possible for the observer 21 to see the scenery through the head mounted display 1.

### Second Embodiment

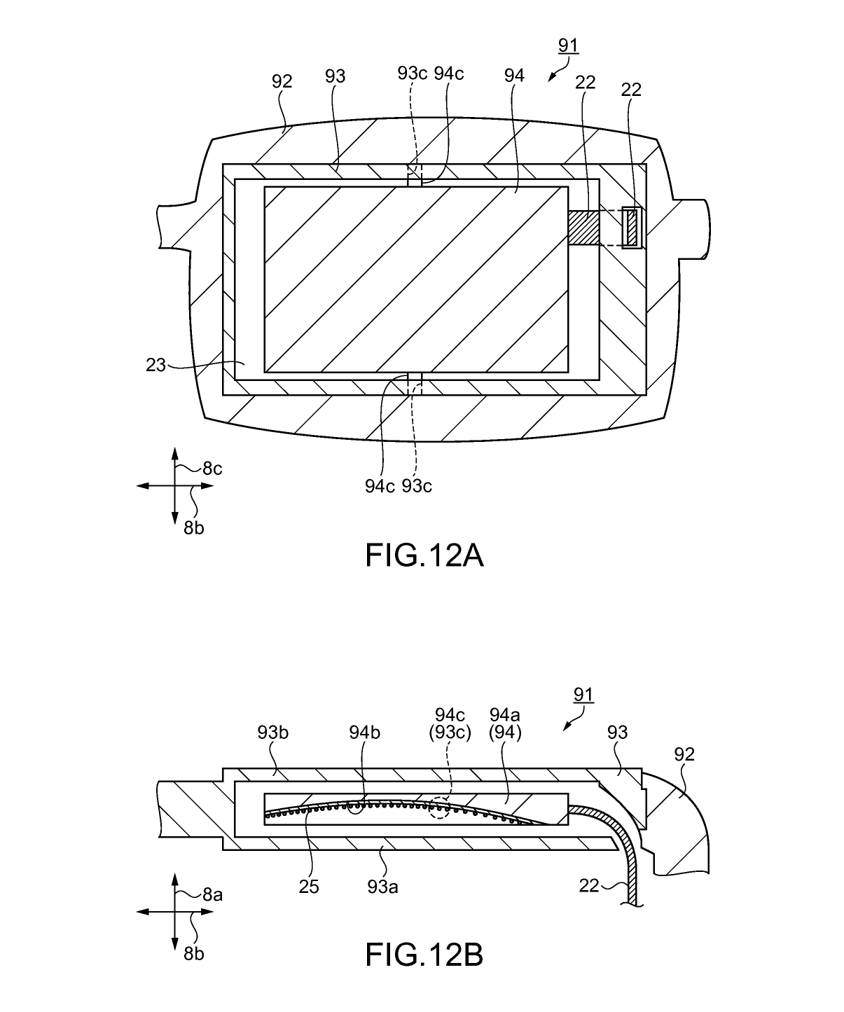

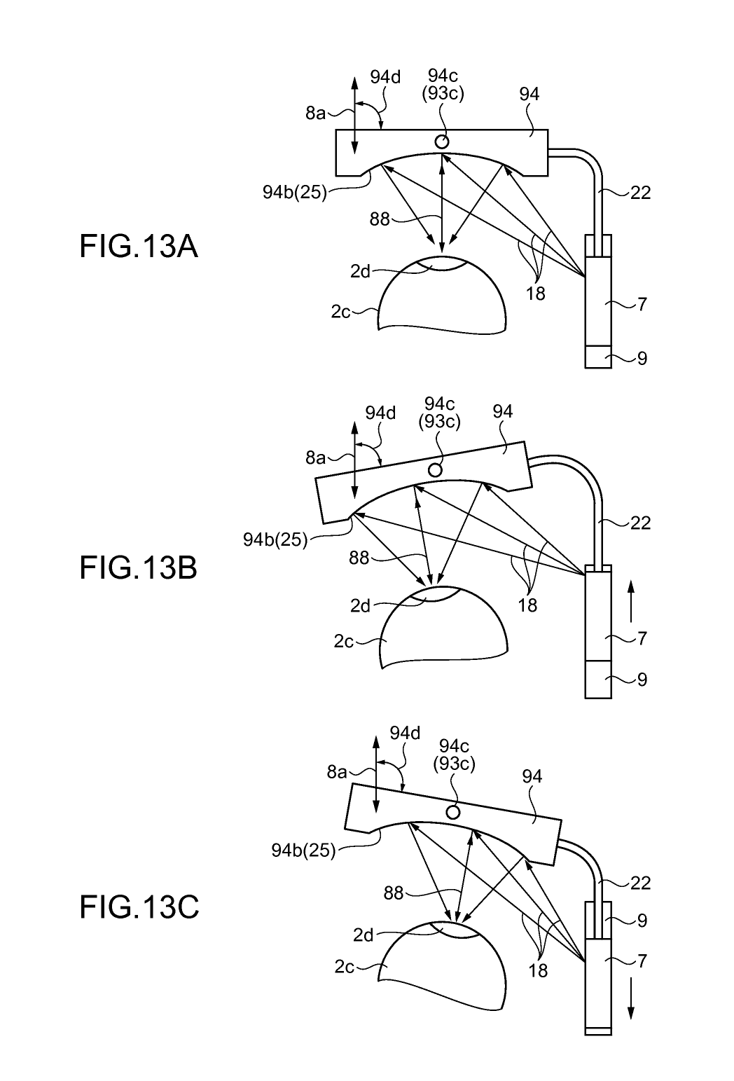

Then, a head mounted display as an embodiment of the invention will be explained using FIGS. 12A, 12B, and 13A through 13C. FIG. 12A is a schematic horizontal cross-sectional view of a principal part showing a structure of the head mounted display, and FIG. 12B is a schematic top cross-sectional view of a principal part showing the structure of the head mounted display. FIGS. 13A through 13C are schematic diagrams for explaining an action of the half mirror. The present embodiment is different from the first embodiment in the point that the half mirror makes an oscillating motion. The explanation of the points the same as in the first embodiment will be omitted. The half mirror for the right eye will be explained. The half mirror for the left eye has substantially the same structure and action, and the explanation thereof will be omitted.

Specifically, in the present embodiment, a head mounted display 91 as the image display device is provided with a half mirror frame 92 as shown in FIGS. 12A and 12B. In the half mirror frame 92, there is disposed a mirror protecting section 93 as a protecting section. A hollow 23 is disposed inside the mirror protecting section 93, and a half mirror 94 as a display section is disposed in the hollow 23. The mirror protecting section 93 is provided with a first window section 93a as a window section and a second window section 93b as a window section so as to be opposed to each other. The half mirror 94 is disposed between the first window section 93a and the second window section 93b. There is a gap between the half mirror 94 and the first window section 93a, and there is a gap also between the half mirror 94 and the second window section 93b. The first window section 93a, the second window section 93b, and the half mirror 94 are each formed of a material having a light transmissive property.

The half mirror 94 is provided with shafts 94c extending in the vertical direction 8c, and disposed at the center in the horizontal direction 8b of the half mirror 94. The shafts 94c are respectively disposed on the side surfaces on both sides in the vertical direction 8c in the half mirror 94. The mirror protecting section 93 is provided with bearings 93c disposed at places located at the center in the horizontal direction 8b of the hollow 23. The bearings 93c are respectively disposed on the surfaces on the both sides in the vertical direction 8c of the surfaces facing to the hollow 23 in the mirror protecting section 93. The shafts 94c are inserted in the respective bearings 93c, and the half mirror 94 is arranged to be rotatable around the shafts 94c as the rotational center.

The connection section 22 is disposed on the right side of the half mirror 94 in the drawing in the place opposed to the right eye, and the connection section 22 connects the half mirror 94 and the drawing device 7 to each other. Therefore, in the case in which the stage 9 moves the drawing device 7 in the front-back direction 8a, the half mirror 94 rotates concurrently with the movement of the drawing device 7.

The half mirror 94 is provided with the plate-like member 94a provided with a concave surface 94b, and the hologram sheet 25 is disposed on the concave surface 94b. The concave surface 94b forms a surface facing to the human head 2.

FIGS. 13A through 13C are diagrams corresponding to the stage moving process of the step S3 and the drawing process of the step S4. As shown in FIG. 13A, in the case in which the pupil 2d faces to the front, the visual line 88 proceeds toward the front of the human head 2. A mirror angle 94d as an angle of the half mirror 94 with respect to the front-back direction 8a is set, and the concave surface 94b and the hologram sheet 25 are formed so that an optimum image can be observed when the mirror angle 94d is an optimum mirror angle. In the step S3, the stage control section 78 controls the stage 9 so that the mirror angle 94d becomes the optimum mirror angle. In the step S4, the drawing device 7 emits the laser beam 18. On this occasion, the laser beam 18 reflected by the half mirror 94 passes through the pupil 2d, and the observer 21 can observe the clear virtual image.

As shown in FIG. 13B, in the case in which the pupil 2d faces to the left side in the drawing, the visual line 88 proceeds toward the left side of the human head 2. In the step S1, the imaging device 10 shoots the pupil 2d, and in the step S2, the image calculation section 82 calculates the angle of the visual line 88 with respect to the front-back direction 8a. In the step S3, the stage control section 78 detects the position of the movable table of the stage 9 via the stage drive device 69. The movable table is connected to the half mirror 94 via the drawing device 7 and the connection section 22. The stage related data 75 includes the data of the position of the mirror angle 94d with respect to the position of the movable table. The stage control section 78 calculates the mirror angle 94d from the stage related data 75 and the position information of the movable table.

Then, the stage control section 78 controls the stage 9 so that the mirror angle 94d at the angle of the visual line 88 thus detected becomes the optimum mirror angle. As a result, the half mirror 94 is disposed at the optimum angle with respect to the visual line 88. In the step S4, the drawing device 7 emits the laser beam 18. On this occasion, the laser beam 18 reflected by the half mirror 94 passes through the pupil 2d, and the observer 21 can observe the clear virtual image.

As shown in FIG. 13C, in the case in which the pupil 2d faces to the right side in the drawing, the visual line 88 proceeds toward the right side of the human head 2. In this case, the stage control section 78 also controls the stage 9 so that the mirror angle 94d at the angle of the visual line 88 thus detected becomes the optimum mirror angle. As a result, the half mirror 94 is disposed at the optimum angle with respect to the visual line 88. In the step S4, the drawing device 7 emits the laser beam 18. On this occasion, the laser beam 18 reflected by the half mirror 94 passes through the pupil 2d, and the observer 21 can observe a clear virtual image.

Therefore, in the case in which the observer 21 moves the visual line 88 in the horizontal direction, the imaging control section 81 and the image calculation section 82 detect the direction of the visual line 88. The stage control section 78 controls the stage 9 so that the mirror angle 94d at the angle of the visual line 88 thus detected becomes the optimum mirror angle. On this occasion, the drawing device 7 is also moved together with the half mirror 94. Thus, the drawing device 7 emits the laser beam 18 from the position where the laser beam 18 reflected by the half mirror 94 is set to pass through the pupil 2d. Therefore, the observer 21 can observe a clear virtual image.

As described above, according to the present embodiment, the following advantages are obtained. (1) According to the present embodiment, in the case in which the observer 21 observing a virtual image moves the visual line 88, the imaging devices 10, the imaging control section 81, and the image calculation section 82 detect the visual line 88 of the observer 21. The control section 15 controls the stages 9, and each of the stages 9 rotates the half mirror 94 in conjunction with the drawing device 7. Thus, the drawing device 7 emits the laser beam 18 from the position where the laser beam 18 reflected by the half mirror 94 is set to pass through the pupil 2d. It is possible to move the virtual image in accordance with the motion of the visual line 88 of the observer 21. Therefore, it is possible for the head mounted display 91 to display a clear image in accordance with the visual line 88 of the observer 21.

### Third Embodiment

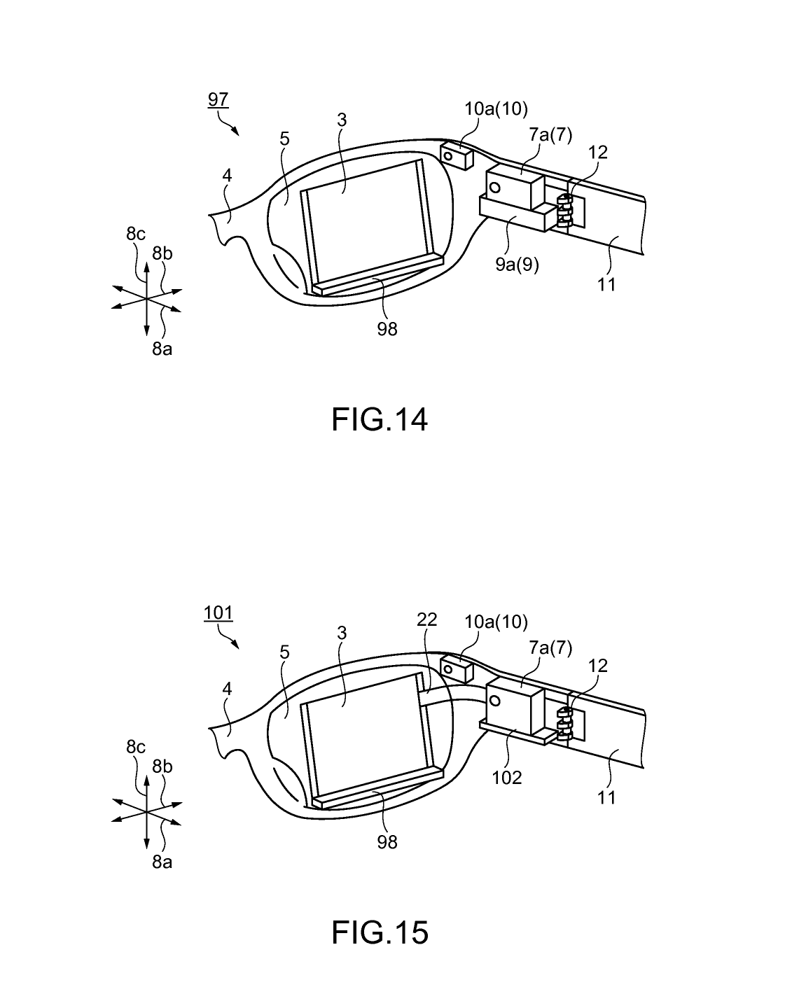

Then, a head mounted display as an embodiment of the invention will be explained using FIG. 14. FIG. 14 is a schematic perspective view of a principal part showing a structure of the head mounted display. The present embodiment is different from the first embodiment in the point that the connection section 22 is eliminated, and a stage for moving the half mirror 3 is disposed. The explanation of the points the same as in the first embodiment will be omitted. The half mirror for the right eye will be explained. The half mirror for the left eye has substantially the same structure and action, and the explanation thereof will be omitted.

Specifically, in the present embodiment, as shown in FIG. 14, the connection section 22 for connecting the half mirror 3 and the drawing device 7 to each other is not provided to a head mounted display 97 as the image display device. In the mirror protecting section 5, there is disposed a stage 98 as a moving section for moving the half mirror 3 in the horizontal direction 8b. The stage drive device 69 drives the stage 9 and the stage 98. The stage 9 moves the drawing device 7, and the stage 98 moves the half mirror 3.

In the case in which the observer 21 observing a virtual image moves the visual line 88, the imaging devices 10, the imaging control section 81, and the image calculation section 82 detect the visual line 88 of the observer 21. The control section 15 controls the stage 9 and the stage 98. The stage 9 moves the drawing device 7 in the front-back direction 8a. The stage 98 moves the half mirror 3 in the horizontal direction 8b. The control section 15 moves the half mirror 3 and the drawing device 7 in conjunction with each other. Thus, it is possible to make the laser beam 18 having been reflected by the half mirror 3 pass through the pupil 2d to thereby move the virtual image in accordance with the motion of the visual line 88 of the observer 21. Therefore, it is possible for the head mounted display 97 to display a clear image in accordance with the visual line 88 of the observer 21.

### Fourth Embodiment

Then, a head mounted display as an embodiment of the invention will be explained using FIG. 15. FIG. 15 is a schematic perspective view of a principal part showing a structure of the head mounted display. The present embodiment is different from the first embodiment in the point that the stage 98 for moving the half mirror 3 is disposed, and the stage 98 moves the half mirror 3 and the drawing device 7. The explanation of the points the same as in the first embodiment will be omitted. The half mirror for the right eye will be explained. The half mirror for the left eye has substantially the same structure and action, and the explanation thereof will be omitted.

Specifically, in the present embodiment, as shown in FIG. 15, the connection section 22 for connecting the half mirror 3 and the drawing device 7 to each other is provided to a head mounted display 101 as the image display device. In the mirror protecting section 5, there is disposed the stage 98 for moving the half mirror 3 in the horizontal direction 8b. The half mirror frame 4 is provided with a guide rail 102 for guiding the translation of the drawing device 7 in the front-back direction 8a. As the guide rail 102, there can be used a linear guide provided with a ball bearing or a roller bearing, or a sheet having a low friction coefficient.

The stage drive device 69 drives the stage 98. The stage 98 moves in the horizontal direction 8b. The drawing device 7 moves in the front-back direction 8a in conjunction with the motion of the half mirror 3. The drawing device 7 is guided by the guide rail 102, and is therefore arranged to be able to be moved with a weak force.

In the case in which the observer 21 observing a virtual image moves the visual line 88, the imaging devices 10, the imaging control section 81, and the image calculation section 82 detect the visual line 88 of the observer 21. The control section 15 controls the stage 98. The stage 98 moves the half mirror 3 in the horizontal direction 8b. The drawing device 7 is moved in the front-back direction 8a in conjunction with the half mirror 3. The control section 15 moves the half mirror 3 and the drawing device 7 in conjunction with each other. Thus, it is possible to move the virtual image in accordance with the motion of the visual line 88 of the observer 21 so that the laser beam 18 having been reflected by the half mirror 3 passes through the pupil 2d. Therefore, it is possible for the head mounted display 101 to display a clear image in accordance with the visual line 88 of the observer 21.

### Fifth Embodiment

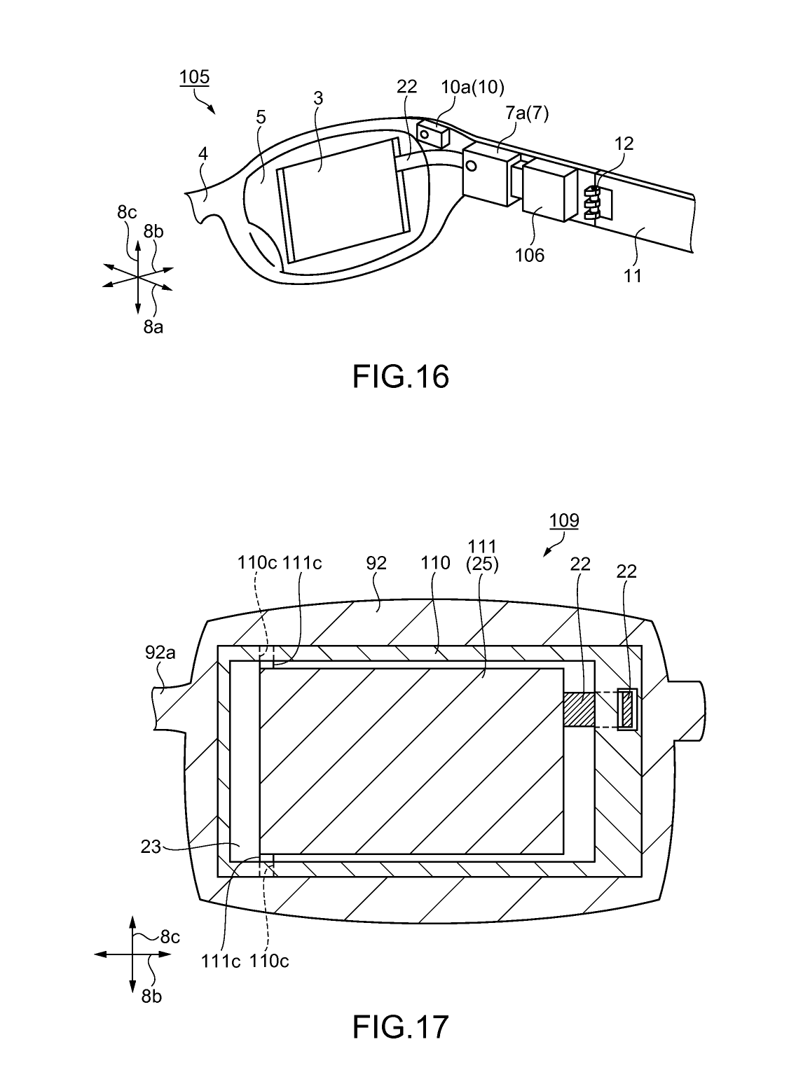

Then, a head mounted display as an embodiment of the invention will be explained using FIG. 16. FIG. 16 is a schematic perspective view of a principal part showing a structure of the head mounted display. The present embodiment is different from the first embodiment in the point that the position of the stage for moving the drawing device 7 is different from the position of the stage 9. The explanation of the points the same as in the first embodiment will be omitted. The stage for the right eye will be explained. The stage for the left eye has substantially the same structure and action, and the explanation thereof will be omitted.

Specifically, in the present embodiment, as shown in FIG. 16, the connection section 22 for connecting the half mirror 3 and the drawing device 7 to each other is provided to a head mounted display 105 as the image display device. In the half mirror frame 4, there is disposed a stage 106 as a moving section for moving the drawing device 7 in the front-back direction 8a. The stage 106 is provided with the same function as the function of the stage 9 in the first embodiment. Therefore, it is possible for the head mounted display 105 to be provided with the same function as the function of the head mounted display 1 according to the first embodiment.

The stage 106 is disposed on the ear 2b side in the front-back direction 8a of the drawing device 7. Therefore, even if the length in the vertical direction 8c of the drawing device 7 increases, the increase can be made inconspicuous with respect to the width of the temple section 11. Therefore, the head mounted display 105 can be made to be a device good in aesthetic. Since the drawing device 7 can be increased in the length in the vertical direction 8c, it is possible to achieve an easy-to-design arrangement of the elements included in the inside of the drawing device 7.

### Sixth Embodiment

Then, a head mounted display as an embodiment of the invention will be explained using FIG. 17. FIG. 17 is a schematic horizontal cross-sectional view of a principal part showing a structure of the head mounted display. The present embodiment is different from the second embodiment in the point that the positions of the shaft 94c and the bearing 93c are different. The explanation of the points the same as in the second embodiment will be omitted. The half mirror for the right eye will be explained. The half mirror for the left eye has substantially the same structure and action, and the explanation thereof will be omitted.

Specifically, in the present embodiment, a head mounted display 109 as the image display device is provided with a half mirror frame 92 as shown in FIG. 17. In the half mirror frame 92, there is disposed a mirror protecting section 110 as a protecting section. The hollow 23 is disposed inside the mirror protecting section 110, and a half mirror 111 as a display section is disposed in the hollow 23. The half mirror 111 is provided with shafts 111c extending in the vertical direction 8c, and disposed on a nose piece 92a side in the horizontal direction 8b. The shafts 111c are respectively disposed on the both sides in the vertical direction 8c in the half mirror 111. The mirror protecting section 110 is provided with bearings 110c disposed on the nose piece 92a side in the horizontal direction 8b of the hollow 23. The bearings 110c are respectively disposed on the surfaces facing to the half mirror 111 on the both sides in the vertical direction 8c in the mirror protecting section 110. The shafts 111c are inserted in the respective bearings 110c, and the half mirror 111 is arranged to be rotatable around the shafts 111c as the rotational center.

The connection section 22 is disposed on the right side of the half mirror 111 in the drawing, and the connection section 22 connects the half mirror 111 and the drawing device 7 to each other. Therefore, in the case in which the stage 9 moves the drawing device 7, the half mirror 111 rotates concurrently with the movement of the drawing device 7. The half mirror 111 has a concave surface formed on the surface facing to the human head 2, and the hologram sheet 25 is disposed on the concave surface.

In the case in which the observer 21 observing a virtual image moves the visual line 88, the imaging devices 10, the imaging control section 81, and the image calculation section 82 detect the visual line 88 of the observer 21. The control section 15 controls the stage 9, and the stage control section 78 controls the stage 9 so that the stage 9 rotates the half mirror 111 in conjunction with the drawing device 7 to set the mirror angle to an optimum mirror angle. As a result, the half mirror 111 is disposed at the optimum angle with respect to the visual line 88. In the step S4, the drawing device 7 emits the laser beam 18. On this occasion, the laser beam 18 reflected by the half mirror 111 passes through the pupil 2d, and the observer 21 can observe a clear virtual image.

### Seventh Embodiment

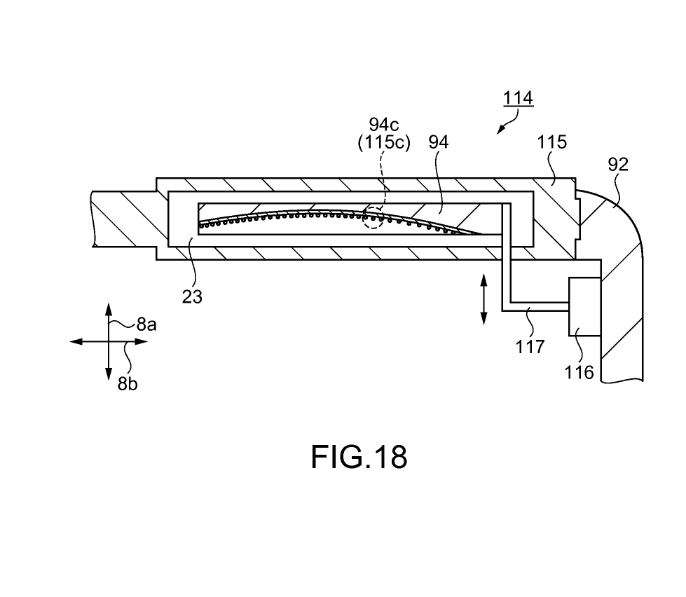

Then, a head mounted display as an embodiment of the invention will be explained using FIG. 18. FIG. 18 is a schematic top cross-sectional view of a principal part showing a structure of the head mounted display. The present embodiment is different from the second embodiment in the point that a mechanism for rotating the half mirror 94 is provided. The explanation of the points the same as in the second embodiment will be omitted. The half mirror for the right eye will be explained. The half mirror for the left eye has substantially the same structure and action, and the explanation thereof will be omitted.

Specifically, in the present embodiment, a head mounted display 114 as the image display device is provided with the half mirror frame 92 as shown in FIG. 18. In the half mirror frame 92, there is disposed a mirror protecting section 115 as a protecting section. The hollow 23 is disposed inside the mirror protecting section 115, and the half mirror 94 is disposed in the hollow 23. The half mirror 94 is provided with the shafts 94c extending in the vertical direction 8c, and disposed at the center in the horizontal direction 8b of the half mirror 94. The mirror protecting section 115 is provided with bearings 115c disposed at the center in the horizontal direction 8b of the hollow 23. The bearings 115c are respectively disposed on the both sides in the vertical direction 8c in the mirror protecting section 115. The shafts 94c are inserted in the respective bearings 115c, and the half mirror 94 is arranged to be rotatable around the shafts 94c as the rotational center.

In the half mirror frame 92, there is disposed a stage 116 as a moving section in a place close to the mirror protecting section 115. In the half mirror frame 92, there is disposed the stage 116 in addition to the stage 9 for moving the drawing device 7. The stage 116 is provided with a direct drive mechanism similarly to the stage 9. The stationary table of the stage 116 is disposed on the half mirror frame 92. On the movable table of the stage 116, there is disposed a connection section 117 as a moving section for connecting the movable table and the half mirror 94 to each other. Thus, the stage 116 is arranged to be able to rotate the half mirror 94 around the shafts 94c as the rotational center.

In the case in which the observer 21 observing a virtual image moves the visual line 88, the imaging devices 10, the imaging control section 81, and the image calculation section 82 detect the visual line 88 of the observer 21. The control section 15 controls the stage 9 and the stage 116. The stage 9 moves the drawing device 7 in the front-back direction 8a. The stage 116 rotates the half mirror 94 around the shafts 94c as the rotational center. The control section 15 moves the half mirror 94 and the drawing device 7 in conjunction with each other. As a result, the half mirror 94 is disposed at the optimum angle with respect to the visual line 88. In the step S4, the drawing device 7 emits the laser beam 18. On this occasion, the laser beam 18 reflected by the half mirror 94 passes through the pupil 2d, and the observer 21 can observe a clear virtual image. It is possible to move the virtual image in accordance with the motion of the visual line 88 of the observer 21. Therefore, it is possible for the head mounted display 114 to display a clear image in accordance with the visual line 88 of the observer 21.

### Eighth Embodiment

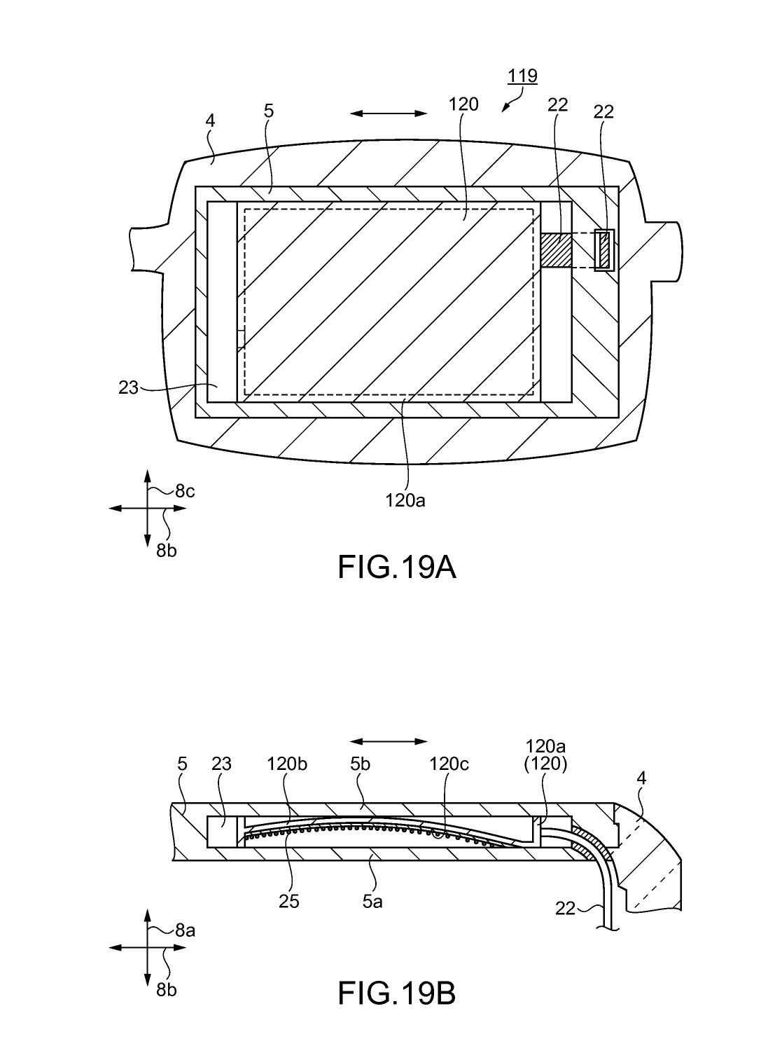

Then, a head mounted display as an embodiment of the invention will be explained using FIGS. 19A and 19B. FIG. 19A is a schematic horizontal cross-sectional view of a principal part showing a structure of the head mounted display. FIG. 19B is a schematic top cross-sectional view of a principal part showing the structure of the head mounted display. The present embodiment is different from the first embodiment in the point that the half mirror has a structure of disposing the hologram sheet on the frame section. The explanation of the points the same as in the first embodiment will be omitted. The half mirror for the right eye will be explained. The half mirror for the left eye has substantially the same structure and action, and the explanation thereof will be omitted.

Specifically, in the present embodiment, a head mounted display 119 as the image display device is provided with a half mirror 120 as the display section as shown in FIGS. 19A and 19B. The half mirror 120 is disposed inside the mirror protecting section 5. The half mirror 120 is provided with a frame section 120a having a rectangular shape. The frame section 120a is arranged to be movable in the horizontal direction 8b along the inner periphery of the mirror protecting section 5.

A thin film 120b is disposed inside the frame section 120a, and the surface of the thin film 120b facing to the human head 2 forms a concave surface 120c. The hologram sheet 25 is disposed on the concave surface 120c. The half mirror 120 has the frame section 120a on which the hologram sheet 25 is disposed. The frame section 120a has certain rigidity, and has certain strength as a structure. Therefore, it is possible to thin a part irradiated with the laser beam 18 to thereby reduce the weight of the half mirror 120. As a result, the half mirror 120 can be moved with a weak force.

The invention is not limited to the embodiments described above, but a variety of modifications or improvements can also be added by those skilled in the art within the technical concept of the invention. Some modified examples will be described below.

### Modified Example 1

In the first embodiment described above, the two imaging devices 10, namely the right-side imaging device 10a and the left-side imaging device 10b, are disposed. It is also possible to detect the visual line 88 using either one of the right-side imaging device 10a and the left-side imaging device 10b. It is also possible for the stage control section 78 to control the half mirrors 3 and the drawing devices 7 located on both sides using the data of the visual line 88 thus detected. Since the number of the constituents is reduced, the head mounted display 1 can be made easy to manufacture.

### Modified Example 2

In the first embodiment described above, the half mirrors 3 are moved by sliding the half mirror 3 with the inner surface of the mirror protecting section 5. It is also possible to dispose a sliding surface low in friction between the half mirror 3 and the mirror protecting section 5. It is also possible to dispose a guide rail between the half mirror 3 and the mirror protecting section 5. The half mirror 3 can be moved with a weak force.

### Modified Example 3

In the first embodiment described above, the first window section 5a and the second window section 5b are disposed in the mirror protecting section 5. Depending on the purpose of the use of the head mounted display 1, it is also possible to dispose the first window section 5a alone, or it is also possible to dispose the second window section 5b alone. Further, it is also possible to eliminate the first window section 5a and the second window section 5b to expose the half mirror 3.

### Modified Example 4

In the first embodiment described above, the concave surface 3b is disposed on the half mirror 3. In the case in which the reflection angle of the laser beam 18 can be controlled by the hologram sheet 25 alone, the concave surface 3b can be changed to a flat surface. Since the shape of the plate-like member 3a is simplified, the plate-like member 3a can be made easy to manufacture.

### Modified Example 5

In the first embodiment described above, there is adopted the structure of disposing the mirror protecting section 5 on the half mirror frame 4. It is also possible to adopt a structure of integrating the half mirror frame 4 and the mirror protecting section 5 with each other. Since the number of components is reduced, the head mounted display 1 can be made easy to manufacture.

### Modified Example 6

In the first embodiment described above, the half mirror 3 is moved in the horizontal direction 8b. Further, it is also possible to dispose a stage for moving the half mirror 3 in the vertical direction 8c. Even in the case in which the visual line 88 moves in the vertical direction 8c, a finely-resolved virtual image can be displayed by moving the half mirror 3.

### Modified Example 7

In the first embodiment described above, the second window section 5b is made light transmissive to thereby arrange that the scenery viewed through the second window section 5b and the virtual image can be seen in a superimposed manner. It is also possible to adopt a light-blocking material as the material of the second window section 5b. It is possible to change the head mounted display 1 to a device for viewing a virtual image alone.

### Modified Example 8

In the first embodiment described above, the light source section 36 is disposed in the drawing device 7. It is also possible to dispose the light source section 36 in the control section 15, and guide the laser beam 18 to the drawing section 29 using an optical fiber. Since the drawing device 7 can be made light in weight, the fatigue caused by wearing the head mounted display 1 can be reduced.

### Modified Example 9

In the first embodiment described above, the drawing section 29 realizes scanning in the two directions with one electrical magnet. It is also possible for the drawing section 29 to have a structure of performing scanning in the two directions with two electrical magnets. The control of the operation can be made easier. The drawing section 29 performs the main scanning and the sub-scanning with the light reflecting surface 37 alone. It is also possible to dispose a reflecting surface for the main scanning and a reflecting surface for the sub-scanning. The control of the scanning can be made easier. It is also possible for the drawing section 29 to drive the light reflecting surface 37 with a piezoelectric element or a drive element using electrostatic action besides the electrical magnet.

### Modified Example 10

In the first embodiment described above, the two drawing devices 7, namely the right-side drawing device 7a and the left-side drawing device 7b, are provided to achieve stereo display. It is also possible to adopt a monocular display device provided with the single drawing device 7. Since the number of the constituents is reduced, the head mounted display 1 can be made easy to manufacture.

### Modified Example 11

In the eighth embodiment described above, the concave surface 120c is formed on the thin film 120b of the half mirror 120, and the hologram sheet 25 is disposed on the concave surface 120c. Besides the above, it is also possible to form the hologram sheet 25 to have a curved surface to directly dispose the hologram sheet 25 on the frame section 120a. Since the shape of the half mirror 120 is simplified, the half mirror 120 can be made easy to manufacture. Since the thin film 120b is eliminated, the half mirror 120 can be made light in weight.

The entire disclosure of Japanese Patent Application No. 2014-222467 filed Oct. 31, 2014 is expressly incorporated by reference herein.

What is claimed is:

1. An image display device comprising:
a light source section adapted to emit a laser beam;
a drawing section adapted to make a mirror reflect the laser beam, and rotate the mirror to draw an image;
a display section adapted to reflect the laser beam to form a virtual image;
a moving section adapted to move the drawing section and the display section in conjunction with each other;
a visual line detection section adapted to detect a visual line of an observer observing the virtual image; and
a control section adapted to control the moving section in accordance with a movement of the visual line.

2. The image display device according to claim 1, wherein
the moving section includes a connection section adapted to connect the drawing section and the display section to each other.

3. The image display device according to claim 1, further comprising:
a protecting section provided with a window section having a light transmissive property,
wherein the display section is disposed in the protecting section.

4. The image display device according to claim 2, further comprising:
a protecting section provided with a window section having a light transmissive property,
wherein the display section is disposed in the protecting section.

5. The image display device according to claim 1, wherein
the display section has a plate having a heat resistance property on which a hologram sheet is disposed.

6. The image display device according to claim 1, wherein
the display section has a frame section on which a hologram sheet is disposed.

7. The image display device according to claim 3, wherein
the window sections are disposed across the display section from each other.

8. The image display device according to claim 4, wherein
the window sections are disposed across the display section from each other.

9. A drawing method comprising:
shooting a pupil of an observer to detect a visual line of the observer;
moving a display section and a drawing section to a place where a laser beam passes through the pupil of the observer; and
emitting the laser beam from the drawing section to the display section to draw a virtual image.
